(19) United States
(12) Patent Application Publication
(10) Pub. No.: US 2003/0216928 A1
(43) Pub. Date: Nov. 20, 2003

(54) Intelligent knowledge exchange platform

(76) Inventor: Shimon Shour, Edgewater, NJ (US)

Correspondence Address: KALOW & SPRINGUT LLP, 488 MADISON AVENUE, 19TH FLOOR, NEW YORK, NY, 10022, US

(21) Appl. No.: 10/147,696

(22) Filed: May 16, 2002

(51) Int. Cl. G06F 17/60

(52) U.S. Cl. 705/1

(57) ABSTRACT

A marketplace for knowledge-based services is provided in which various entities interact according to a hierarchy of business rules. A service provider can affiliate with an enterprise or sub-enterprise via an office, which serves as a unique virtual view of the professional's intellectual capital. The system uses predefined terminology sets to facilitate efficient matching of service requests to service providers and to facilitate efficient knowledge exchange.

### BACKGROUND

Many people have predicted a knowledge revolution, in which intellectual capital, knowledge, expertise, and other intellectual assets, rather than goods and services, are primary economic drivers. Many industries, such as healthcare, law, education, engineering, and others build their businesses on the exchange of intellectual capital. However, despite their promise, intellectual capital markets have many challenges. For example, organizations and individual professionals often have difficulty expanding beyond local markets, due to expenses of travel, difficulties in finding skilled professionals, and other barriers. Organizations have difficulty recruiting adequate numbers of highly skilled professionals in many localities. Where professionals are available locally, labor costs are often exceedingly high. The next result is that in many localities it is cost-prohibitive to have enough knowledge professionals, meaning that people in such localities are not able to access the highest level of professional knowledge.

Another challenge is that with mechanisms such as the Internet that allow remote delivery of services, knowledge professionals find it increasingly difficult to distinguish themselves, because they lack the opportunity to make direct contact with service requesters, or because they have difficulty describing their field of expertise. Thus, potential knowledge exchange transactions do not occur. Also, while the Internet and email allow the potential for knowledge exchange, the absence of good mechanisms for ensuring credibility of the information that is exchanged means that this resource is often untapped, contributing to a high degree of industry fragmentation.

Mechanisms for online delivery of professional services often suffer from a problem of credibility. Service requesters are unable to access traditional mechanisms for determining reliability, such as in-person meetings, or known references. Thus, a need exists for mechanisms to assure credibility and reliability of service providers.

One marketplace where these problems are acute is the area of health care. Top health care researchers are concentrated in a small number of hospitals in a small number of cities, many of which are in only a handful of countries. Health care knowledge and particularly health care research knowledge is not distributed evenly across the globe or within countries, and it will never be distributed evenly. Meanwhile, health care needs are global. When a remote service requester seeks advice from a health care professional, there is a high degree of need to establish credibility. However, even when a professional is online (as is not always the case), it is difficult for the professionals to classify themselves in a way that makes them easily accessible.

### SUMMARY

Provided herein is an intelligent knowledge exchange platform, with a variety of components and facilities that address the problems of conventional knowledge markets. An overall marketplace is established in which a variety of entities interact pursuant to rules that support intellectual capital transactions. The market includes the capacity to build and maintain a variety of enterprises. Each enterprise can maintain rules that allow other enterprises, as well as sub-enterprise entities, to interact with or within that enterprise. Entities that may participate in the marketplace may include individual service providers, information content providers, and groups of these. These entities can participate in more than one enterprise, with different interaction rules established by each enterprise for interactions with it. Through an office, an individual professional may affiliate with a particular enterprise, for example an institution or company. The system is hierarchical, with marketplace rules applying to all entities, additional enterprise rules applying to all entities interacting with that enterprise, and additional sub-enterprise rules applying to entities interacting with that sub-enterprise. Thus, increasing layers of rules can be used to facilitate exchange transactions requiring any degree of complexity.

It should be understood that the term intellectual capital, as used herein, encompasses knowledge, expertise, and other intellectual assets.

In embodiments, enterprise rules are designed to facilitate commoditization of an individual's, group's, company's or institution's knowledge. The system may use a vocabulary and semantic rule set that is appropriate for a particular profession, e.g., health care, so that a given service provider's expertise is captured in terms that can be effectively compared by potential service requesters for purposes of selecting a service provider. Each service provider can thus register with the system in a way that facilitates presenting that provider in a way that is consistent with the terminology and needs of the enterprise and market in question, and the service provider can maintain or modify its representative knowledge set over time, as that knowledge set evolves, or as new aspects of the knowledge set become relevant.

Methods and systems disclosed herein facilitate an efficient, global marketplace for knowledge-based services. They include processes and systems for providing a set of market rules for allowing entities to interact in the marketplace; providing a builder application for allowing an enterprise to define a set of enterprise rules for interacting with the enterprise, the enterprise rules consistent with the market rules; and providing a profiling module for allowing a service provider to register with an enterprise, the profiling module facilitating creation of a representation of the service provider's knowledge consistent with the enterprise rules and the market rules. In embodiments a service provider can use an office module to establish a view of the service provider's knowledge that is consistent with the nature of the service provider's desired interaction with the enterprise.

The marketplace can require use of terminology selected from a predefined terminology set. The terminology set can be any predefined set, such as a health care set, a medical set, a surgical set, a legal set, an engineering set, an accounting set, a manufacturing set, a science set, a biology set, a chemistry set, a physics set, a mathematics set, an economics set, a language set, a linguistics set, a consulting set, a business set, a biotechnology set, a telecommunications set, a computer language set, a computer science set, a research set, or a corporate set.

In embodiments a builder application facilitates creation of sub-enterprises having sub-enterprise rules that are consistent with the enterprise rules. A profiling module can facilitate the creation of multiple views of a service provider's knowledge. The multiple views allow the service provider to interact with different enterprises according to different preferences of the service provider.

In embodiments methods and systems are provided for creating a marketplace for knowledge. Methods and systems can provide for creating a set of rules for governing interactions of a plurality of entities in the marketplace, the entities being, for example, enterprises, sub-enterprises, service providers or service requesters; enabling enterprises and sub-enterprises to establish rules for allowing other entities to interacting with them; creating a hierarchy of entities within the marketplace; and providing for inheritance of rules by entities according to the hierarchy. The methods and systems can use the predefined terminology sets, such as those listed above.

In embodiments methods and systems are provided that include processes for providing an enterprise builder tool for allowing an administrator to define a set of rules for an enterprise to operate in the marketplace; providing a sub-enterprise builder tool for allowing the administrator to set rules for a sub-enterprise to operate in the marketplace, the sub-enterprise builder tool configured to allow sub-enterprise rules that are consistent with the rules for a parent enterprise of the sub-enterprise; and providing a profiling module for allowing a service provider to represent a knowledge set of the service provider. The profiling module can allow the service provider to create multiple views of the service provider's knowledge set, using a predefined terminology set such as described above.

In embodiments a service request module is provided for allowing a service requester to form a service request. The module can require use of a predefined terminology set such as listed above. A matching module may be provided for matching a service request to at least one service provider. A transaction module may be provided for supporting a transaction between a service requester and a service provider.

In embodiments a method of facilitating affiliation of an enterprise with a knowledge marketplace is provided, with systems and processes for providing a builder application for allowing the enterprise to enter enterprise information in a format consistent with rules for the marketplace; providing a classification process for allowing the enterprise to classify itself in at least one category among a set of categories of enterprises; providing a business rule process for allowing the enterprise to determine business rules by which others may do business with the enterprise; and providing a transaction module for allowing an entity to transact business with the enterprise. The methods and systems described herein may be facilitated through a web-based application, a downloaded computer software program, an application service provider module, or any other conventional methods for providing an interface to a computer-based service.

In embodiments methods and systems are provided for facilitating a marketplace. They may include an enterprise interface for allowing an enterprise to join the marketplace; a service provider interface for allowing a service provider to affiliate with an enterprise; a service requester interface for allowing a service requester to make a service request; and a matching module for matching a service request to at least one service provider, wherein the service requester interface requires the service requester to make the service request using terminology from a predetermined terminology set such as listed above.

In embodiments methods and systems are provided for facilitating a service between a service requester and a service provider, including processes and systems for providing a profiling process for allowing a plurality of service providers to establish a profile of the service provider's intellectual capital; providing a data requirements definition process for allowing a service provider to establish the data it requires in order to perform a service; providing a request process for allowing a service requester to request service; and providing a matching process for matching the request for service to a service provider. These may use a predefined terminology set such as described above. The marketplace may be for specialized knowledge.

In embodiments a profiling process may include establishing a set of knowledge qualifications for representing knowledge and representing the knowledge qualifications of the knowledge provider as a commodity. A transaction facility may facilitate a transaction among a service requester and a service provider. In embodiments the price of the transaction may make reference to a commodity representation of the knowledge provider's knowledge.

In embodiments, methods and systems are provided for supporting a marketplace for knowledge. The methods and system may include a communications facility for supporting communications among a plurality of geographically distributed parties; a data storage facility for storing data that is associated with the knowledge of a knowledge provider; and an interaction process for supporting an interaction among a service provider and a service requester, wherein the interaction process comprises a facility for representing a knowledge set of a knowledge provider as a commodity. The marketplace may be for specialized knowledge, such as medical knowledge, health care knowledge, surgical knowledge, animal health knowledge, legal knowledge, intellectual property knowledge, accounting knowledge, auditing knowledge, environmental knowledge, consulting knowledge, management consulting knowledge, sales knowledge, marketing knowledge, engineering knowledge, scientific knowledge, chemistry knowledge, biology knowledge, biochemistry knowledge, civil engineering knowledge, industrial management knowledge, education knowledge, publishing knowledge, public relations knowledge, investment banking knowledge, securities knowledge, insurance knowledge, sports knowledge, interest group knowledge, patient association knowledge, association knowledge, or manufacturing knowledge.

In embodiments there may be a representation process of the interaction module, wherein the interaction module includes processes for establishing a set of knowledge qualifications for representing knowledge, determining the knowledge qualifications of a knowledge provider consistent with the set of knowledge qualifications, and representing the knowledge qualifications of the knowledge provider as a commodity according to the set of knowledge qualifications. A transaction facility may facilitate a transaction among a knowledge seeker and a knowledge provider. A price for the transaction may make reference to the commodity representation of the knowledge provider's knowledge.

In embodiments methods and systems are provided for providing a knowledge marketplace. The methods and systems may include processes for providing a host computer system for facilitating the manipulation of data related to the marketplace, wherein the host computer system comprises at least one server, at least one database, and at least one operating system; accessing a communication facility for facilitating remote interaction with the host computer system, wherein the communication facility is selected from the group consisting of the Internet, the Worldwide Web, an intranet, a local area network, a wireless network, and a wide area network; providing an interaction module for facilitating an interaction among a provider of knowledge and a seeker of knowledge, wherein the interaction process comprises a communication facility and a facility for representing the knowledge set of a provider as a commodity; providing a profiling process of the interaction module wherein the interaction module further comprises establishing a set of knowledge qualifications for representing knowledge, determining the knowledge qualifications of a knowledge provider within the set, and representing the knowledge qualifications of the knowledge provider as a commodity; and providing a transaction facility, wherein the transaction facility facilitates a transaction among a knowledge seeker and a knowledge provider, wherein determining the price of the transaction comprises making reference to the commodity representation of the knowledge provider's knowledge. The marketplace can be for knowledge and expertise of many types as mentioned above.

In embodiments methods and systems are provided for providing a marketplace for a professional service. The methods and systems may include facilities for providing a facility for permitting a service provider to digitally present a service offering that it wishes to provide through the marketplace; establishing a hierarchy of the types of services that are provided in the profession of the service provider; using a predefined semantic terminology set for describing the types of services provided in the profession of the service provider; and establishing a profile9 building module for assisting the service provider in creating a service description that uses the semantic terminology and that positions the service offering in the hierarchy.

In embodiments methods and systems are provided for matching a service provider to a service request. The methods and systems may include facilities for establishing a semantic terminology for a domain of the request; establishing a hierarchy of services that can be provided within the domain; facilitating a service request using the semantic terminology, the service request having service requirements; identifying a position within the hierarchy of a service that matches the requirements of the service request; and identifying a service provider who provides the service. With these, the marketplace may support a transaction between the service provider and the requester of the service request wherein the service provider provides the service. In embodiments a service request may be a request for services from multiple service providers, wherein the step of identifying a service provider identifies multiple service providers.

In embodiments methods and systems are provided for facilitating knowledge exchange. The methods and systems may include establishing a process for allowing a service requester to request a knowledge-based service from a service provider; establishing a prerequisite data set desired by the service provider for assisting the service provider in determining whether to accept a request for service; and routing a service request to a service provider based on completed data sets of a service requester. The service may be provided online, or through a combination of online and offline steps (e.g., store and forward or store and retrieve models). References to online services throughout should be understood to encompass completely online services, as well as services that combine online with offline steps.

In embodiments methods and systems for facilitating a marketplace for knowledge may include accessing a communications facility for supporting communications among a plurality of geographically distributed parties; providing a data storage facility for storing data that is associated with the knowledge of a knowledge provider; and providing an interaction process, for supporting an interaction among a provider of knowledge and a seeker of knowledge, wherein the interaction process comprises a facility for representing the knowledge set of a knowledge provider as a commodity using a predetermined terminology set.

### BRIEF DESCRIPTION OF FIGURES

FIG. 1 is a schematic diagram showing entities that participate in a marketplace for knowledge exchange.

FIG. 2 is a schematic diagram depicted entities that participate in an improved marketplace for structured knowledge exchange in accordance with the present disclosure.

FIG. 3 depicts entity interactions among participants in a hierarchical marketplace for structured knowledge exchange.

FIG. 4 is a flow diagram that depicts the steps by which an enterprise may register with the marketplace described herein.

FIG. 5 is a flow diagram depicting steps by which an enterprise may be profiled in accordance with the present disclosure.

FIG. 6 is a schematic diagram that depicts the steps by which entities may interact in a marketplace according to the present disclosure.

FIG. 7 is a schematic diagram that depicts high-level system components for computer systems to support a marketplace such as that disclosed herein.

FIG. 8 is a schematic diagram that depicts components of a host computer system.

FIG. 9 is a schematic diagram that depicts components for a computer system for a professional, office, enterprise or other content provider who participates in the marketplace described herein.

FIG. 10 is a flow diagram depicting steps for registration and profiling of a professional for participation in the marketplace described herein.

FIG. 11 is a flow diagram depicting steps for handling administration of the profile for an office that participates in the marketplace.

FIG. 12 is a flow diagram depicting steps for facilitating a consultation between a service requester and a service provider.

FIG. 13 is a flow diagram depicting steps for guiding data entry to facilitate a matching process for matching a service request with a service provider.

FIG. 14 is a schematic diagram that depicts aspects of a matching process for matching a service request with a service provider.

FIG. 15 is a flow diagram setting out steps for a pre-consultation data entry process of the present marketplace.

FIG. 16 is a screen display for a service provider registration screen.

FIG. 17 is a screen display for an expanded service provider registration screen.

FIG. 18 is a screen display for a service provider to indicate practice specialties.

FIG. 19 is a screen display for a service provider to rank preferences for practice areas.

FIG. 20 is a screen display for a service provider to preview the service provider's profile.

FIG. 21 is a screen display for a service provider to review case status information and details about a case.

FIG. 22 is a screen display for a service provider to answer questions and provide conclusions.

FIG. 23 is a screen display for a service requester to register with the system.

FIG. 24 is a screen display showing an expanded view in which a service requester can enter and view information for a service request.

FIG. 25 is a screen display for a service requester to enter questions.

FIG. 26 is a screen display for a service requester to enter data in fields that permit the matching of a service provider to a service request.

### DETAILED DESCRIPTION

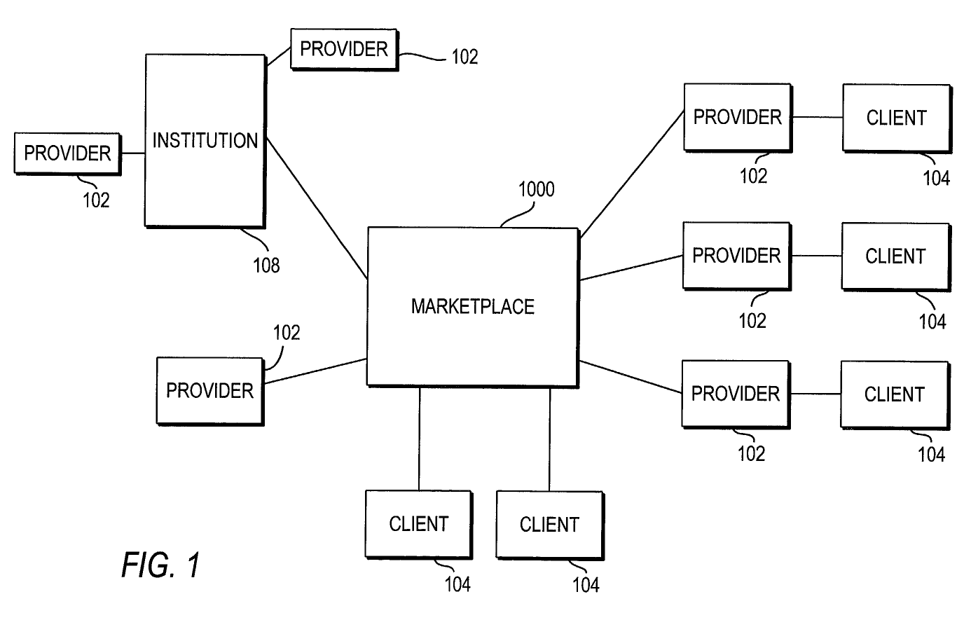

Referring to FIG. 1, a marketplace 100 for knowledge exchange includes a variety of entities, including service providers 102, service requesters or clients 104, and one or more enterprises 108, which may be companies, groups, partnerships, associations, institutions, non-profit entities, or other multi-person entities. As can be seen in FIG. 1, such a marketplace can include various interaction patterns, including those where requesters 104 request services through providers 102, through institutions 108, or directly from the marketplace 1000, as well as those in which providers 102 provide services through other providers 102, through institutions 108, or directly to the marketplace 1000. In such a marketplace, it can be seen that considerable confusion can result if requesters 104 and providers 102 are not highly familiar with each other or with the rules for interacting with each other. Thus, as disclosed below, a need exists for a structure that eliminates such confusion.

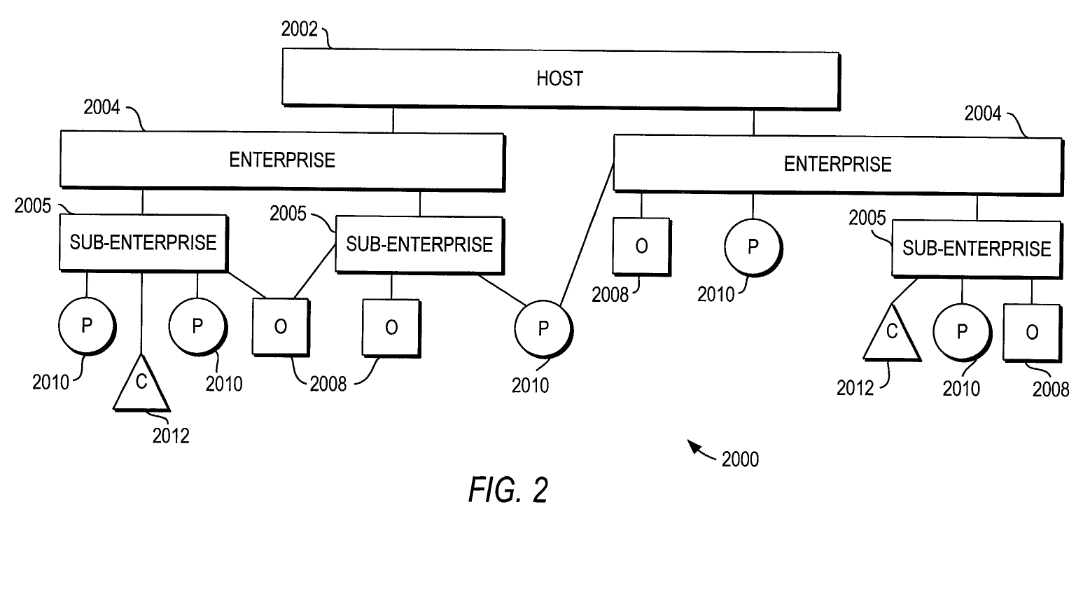

Referring to FIG. 2, an embodiment of an improved marketplace 2000 for knowledge exchange. The marketplace 2000 may be facilitated by actions of a host 2002. The host 2002 oversees the marketplace, which may be a global marketplace servicing many entities, including service providers 2010, content providers 2012, offices 2008 and enterprises 2004. FIG. 2 depicts the service provider side of the marketplace. A service requester may interact with any one of these entities as described below. In an embodiment that interaction occurs first with an enterprise according to its rules, then with a service provider who operates through that enterprise. As seen in FIG. 2, the entities are arranged in a hierarchy, with entities toward the top of FIG. 2 setting rules that govern interactions with them by entities lower in FIG. 2. For example, the host 2002 sets rules for various enterprises 2004, under which they participate in the marketplace 2000. Additional entities may serve as sub-enterprises 2005 of the top-level enterprises (with any number of sub-enterprises 2005 being possible, as well as any number of levels of sub-enterprise 2005 for a given enterprise 2004). Enterprises 2004 should be understood to participate in different kinds of marketplaces (e.g., geographic marketplaces, marketplaces for particular domains (e.g., health care, legal, engineering, education, etc.), marketplaces for specific goods and services, and the like). Enterprises 2004 may also be known as institutions, companies, groups, associations, affiliations, or other entities that can participate in a marketplace and that have their own rules for interacting with other entities. For example, in a health care marketplace, an enterprise might be a hospital, or a university. Similarly, in a legal marketplace, an enterprise might be a law firm, or a law department of a corporation. As see in FIG. 2, it is also possible for offices 2008 to interact with any level of enterprise 2004, or to act independently within the marketplace 2000. In embodiments, an enterprise 2004 can be described as an autonomic, multi-tiered, hierarchical, industry-specific, profile-based, branded cyber-presence that defines the rules for, and manages the exchange processes conducted by offices, lower-level enterprises, and other entities within the rules of a global marketplace 2000.

An office should be understood to include a virtual office of an individual professional or service provider. An office may have multiple views, allowing an individual professional to associate or affiliate with one or more enterprises or sub-enterprises. Thus, a professional might have an office affiliated with a university hospital and affiliated with a private practice, with the single office offering different views of that professional. Other groups that affiliate with each other for purposes of providing services, such as companies, partnerships, associations, groups, affiliates, ventures, departments, or the like, as well as offices in the conventional sense, should be understood to be encompassed by enterprises or sub-enterprises as used herein. One specialized sort of sub-enterprise or enterprises is a colony, which is a term used to describe certain health care sub-enterprises herein.

Service providers 2010 may encompass individual services providers, as well as groups of them. Also participating are the content providers 2012, which should be understood to encompass individuals or entities that provide information, data, or related content or services that are related to the marketplace 2000, but which are not of the type for which the marketplace 2000 was established. For example, they might provide educational content about the domain for which the marketplace is established.

In the hierarchy of FIG. 2, each enterprise follows the global rules of the host 2002, while each sub-enterprise 2004 follows the rules of any parent enterprise 2004. Any office 2008, service provider 2010, or content provider 2012 that participates through an enterprise 2004 follows the global marketplace rules as well as the rules for that enterprise 2004. A given office 2008, service provider 2010, or content provider 2012 can participate in multiple enterprises 2004, such as if a service provider is a professional who has different areas of expertise and wishes to be viewed in different ways in different enterprises.

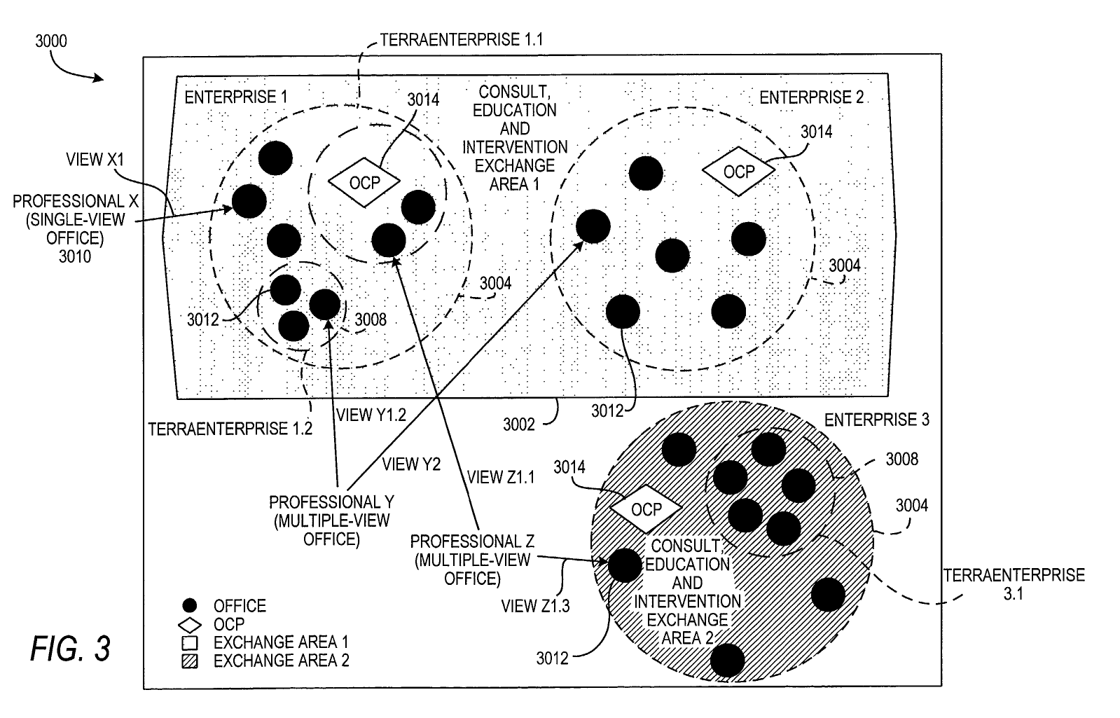

Referring to FIG. 3, a schematic is provided for an embodiment of a health care marketplace 3000. Of course other marketplaces such as legal, engineering, accounting, or the like can also have the same type of form. The marketplace 3000 introduces an additional concept, namely exchange areas 3002, which are areas within the global marketplace 3000 in which enterprises and other entities can interact with each other. What exchange areas 3002 an enterprise can participate can be established through the rules of the enterprise itself. Thus, the exchange areas are defined by the overlap of defined areas of exchange set by multiple enterprises. Within the exchange areas are health care enterprises 3004, which may be of various types such as the enterprises 2004 described in connection with FIG. 2. The enterprises 3004 can, for example, be hospitals, clinics, universities, HMOs, or other health care entities. Within each enterprise 3004 are various other entities, such as sub-enterprises 3008 (which might be departments, for example, of the enterprises), offices 3010 (e.g., doctor's offices), professionals 3012, and other content providers 3014. As in the marketplace 2000 of FIG. 2, enterprise rules govern sub-enterprises and other entities. Any professional can interact with multiple enterprises 3004, even in different exchange areas 3002. Thus, a professional can have a variety of “views” in his office by which the professional can interact with enterprises and other entities, and by which any external entities can view the professional. For example, a doctor might present himself as a kidney specialist in connection with interactions with a given hospital enterprise, and as researcher in connection with interactions with a given educational institution enterprise.

In embodiments, each enterprise is comprised of various offices for individual professionals or services providers who affiliate with the enterprises through the offices. It is also possible that the enterprise will include other content providers who provide related content.

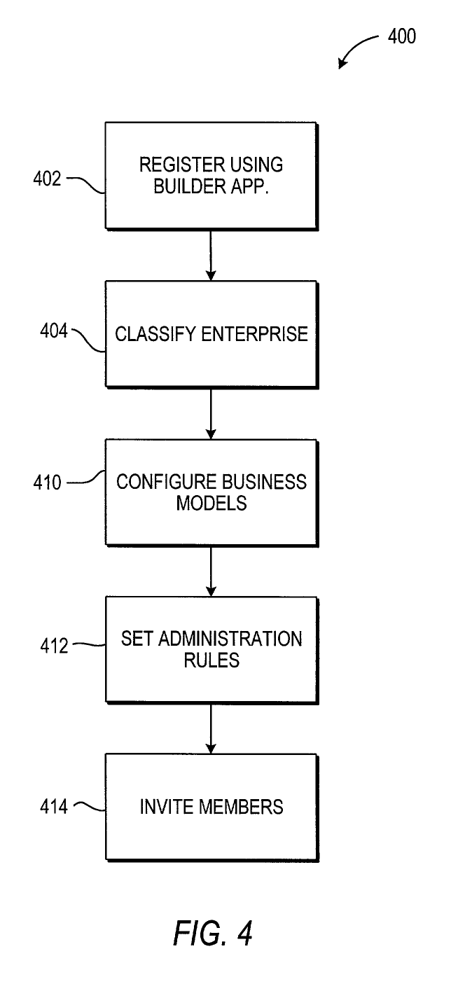

Referring to FIG. 4, a flow diagram 400 depicts high-level steps by which an enterprise may be registered and built. First, at a step 402, the enterprise registers using a builder application designed to build an enterprise. This may be accomplished by an administrator who interacts with the application. The application may be a web-based application, an application served by an ASP model, a client program downloaded on the administrator's computer, a combination of these, or it may be delivered by any other conventional way of delivering software known in the art. Next, at a step 404 the enterprise classifies itself according to the classification rules of the marketplace. The classification rules may include categories of classification, using a terminology set and hierarchy suitable for that marketplace. For example, in the legal field, the enterprise might classify itself as a law firm, a private company, or non-profit organization.

At a step 410 the enterprise can optionally configure business models by which entities can interact with the enterprise, such as fixed fees, service-based fees, hourly fees, or transaction-based fees, both as the enterprise interacts within the global marketplace and as the entities interact with or within the enterprise. The creation, management and maintenance of an enterprise can be accomplished by the administrator, who sets the administration rules for the enterprise, which must not be inconsistent with the rules of the overall marketplace. Thus, an enterprise may have an administrator who handles a variety of administrative functions in compliance with enterprise rules, which can be established at a step 412. There can be any number of enterprises, sub-enterprises, service providers, and other entities within the overall marketplace. Once established, each enterprise sets the rules for entities below it in the hierarchy, including rules for interacting and exchanging intellectual capital. Member entities can exchange and interact according to the enterprise rules. Interactions can include fee-based exchanges, as well as educational and networking exchanges. A given entity, such as a professional, may associate with multiple different enterprises, which allows the professional to segment services, in which case a given enterprise only governs the particular view of that professional that is established with that enterprise. Meanwhile, data for a particular professional or office may be centrally stored, and thus universal for the entire marketplace, with different views of the data applying for different enterprises. An enterprise may be provided with various market management tools, including event flagging, event driven data distribution, promotions catalogs, reporting tools and decision support tools. In embodiments, the administrator uses the builder application to set up frames or similar facilities for allowing service providers to enter content into them. The frames can embody the business rules for the enterprise, for example by indicating which content must be entered in order for a service provider to join the enterprise, or by indicating what content must be provided in order for a transaction to occur with the enterprise.

Next, at a step 414, the enterprise can invite various members, such as sub-enterprises, professionals, and other content providers, to participate in the enterprise. The other entities join, for example, by completing required content in the fields and frames established by the administrator for that enterprise.

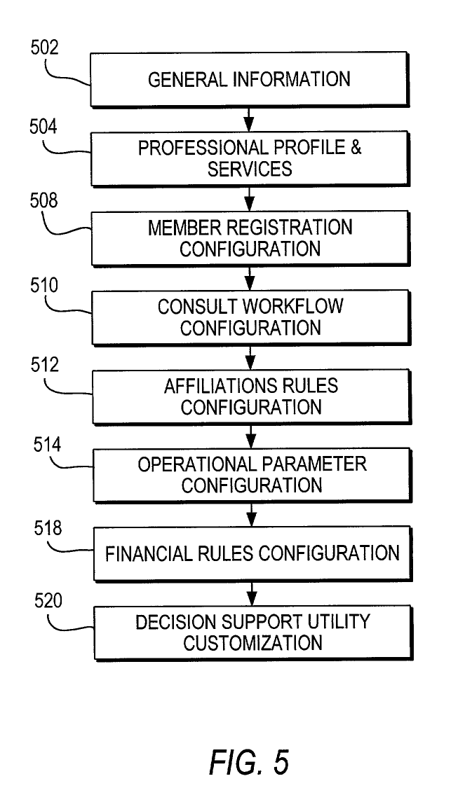

Further details of the profiling and building of an enterprise are provided in a flow diagram 500 of FIG. 5. The steps of the diagram 500 can be accomplished by interaction of an administrator with a builder application. At a step 502 an enterprise provides general information for identification, contact, communications and security purposes. At a step 504, a matrix is established showing the enterprise's professional domains and available services and solutions, which can be gathered incrementally as individual professionals register as members and indicate their particular areas of expertise and services. Next, at a step 508, an administrator for the enterprise defines the sections, attributes and overall flow of the registration process to be completed by member entities of the enterprise, such as professional providers, requesters, other content providers and lower-level enterprises. Next, at a step 510 the administrator can establish the workflow of the process by which a service provider will interact with a service requester for that enterprise (e.g., the work flow for a health care consultation). Next, at a step 512, the administrator establishes the rules by which members users and entities will interact. These rules can be segmented by service types, service domains, dynamic service availability, and other factors that affect when and how a service should be provided. In an embodiment, open exchanges are provided as a default. Next, at a step 514, the administrator can set various parameters, such as work load limitations, response time requirements and the like that overlay other interaction rules for the enterprise. Next, at a step 518, the administrator can set the rules by which financial transactions can take place, such as membership fees, service pricing, discounting, financial transaction triggering, and the like, all of which can be customized for particular transactions with and within the enterprise. Finally, at a step 520, the administrator can customize decision support rules to assist users in making decisions relevant to exchange transactions occurring with or within the enterprise.

It should be understood that while the builder process of FIG. 5 applies to building an enterprise, similar steps can accomplish the creation and registration of an other content provider, such as one that trades with domain-related products and services but is not a professional per-se within an enterprise (e.g., a pharmaceutical or insurance company in the health care domain).

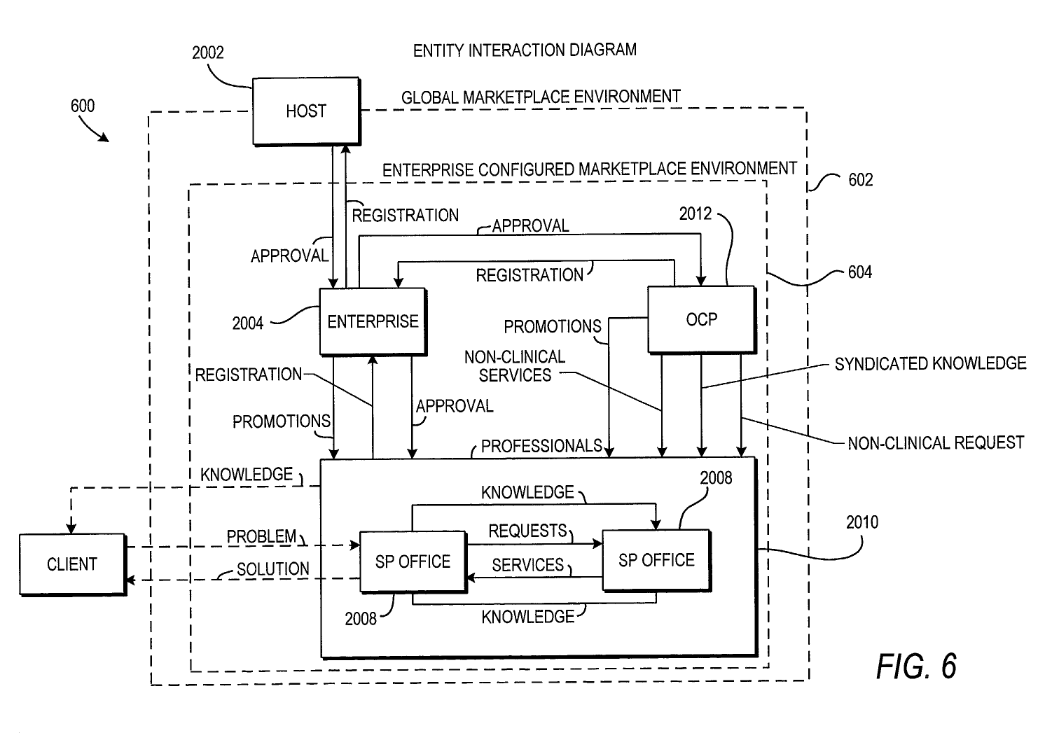

Referring to FIG. 6, a diagram 600 shows interactions between various entities within a marketplace 602. The host 2002 administers the marketplace 602, which includes a configured environment 604 for one or more enterprises. Within the configured environment 604 an enterprise 2004 and another content provider 2012 operate. The enterprise 2004 registers with the host 2002 and obtains approval for registration, pursuant to marketplace rules. The other content provider 2012 and one or more professionals 2010 (here arranged in offices 2008—one a service requester office and the other a service provider office) register with the enterprise and receive approval pursuant to rules for the enterprise. The administrator for the enterprise (or sub-enterprise or colony) can handle the signup process, performing a verification process after data is entered and approving or denying approval of entry into the enterprise. The enterprise can offer various programs and promotions (e.g., information) to professionals 2010 and offices 2008 within the enterprise. The other content provider 2012 can provide promotions, knowledge and various services to professionals 2010 or offices 2008. Service providers and services requesters (each forming offices 2008) can exchange knowledge, with service providers providing services in response to requests by requesters. In embodiments, a client outside the system provides a problem to the service-requesting office and receives a solution, and perhaps knowledge, in return. Although the service provider and service requester are here from the same entity, it is possible that a service requester be an outside entity who contacts the enterprise, subject to affiliation rules for the enterprise.

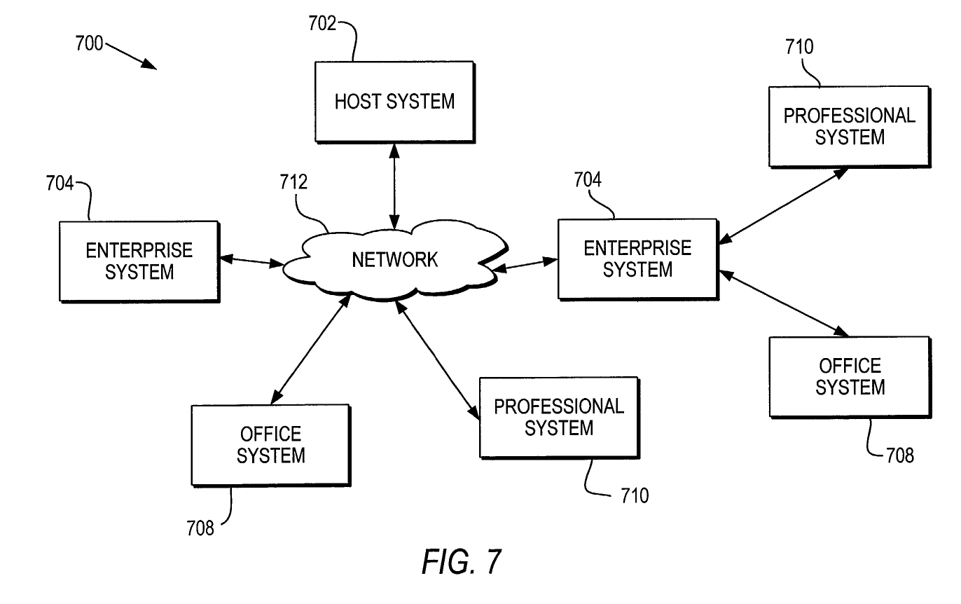

Referring to FIG. 7, a schematic diagram shows high-level system components for a computer system 700 to support an intelligent knowledge exchange market. The computer system 700 includes system elements for various elements that participate in the marketplace. Thus, there is a host system 702 that facilitates performance of the various functions of the host 2002 of the marketplace. There is also a plurality of enterprise systems 704 that facilitate functions of the enterprises 2004 that participate in the marketplace. Similarly, there are a plurality of office systems 708 to facilitate functions of offices 2008 and a plurality of professional systems 710 that facilitate functions of professionals 2010. These systems may be connected by a communications facility, such as a network 712, which in an embodiment is the Internet, but which in other embodiments might be a portion of the Internet, such as the worldwide web, or a wide area network, local area network, wireless network, intranet, dedicated line, or other network or communication facility for allowing connection between the various entities. In embodiments, the system for the marketplace is a web-based system, with each of the host system 702, enterprise system 704, professional system 710, and office system 708 comprising not separate systems, but rather interfaces for interaction with the central web-based system. A suitable interface might be as simple as a browser or similar facility for providing web access. In other embodiments the interfaces may be provided using a client computer program downloaded onto the various computer systems, with suitable interface software for providing an interface to the overall system. In embodiments the software may be served to the various entities by an ASP model or similar facility.

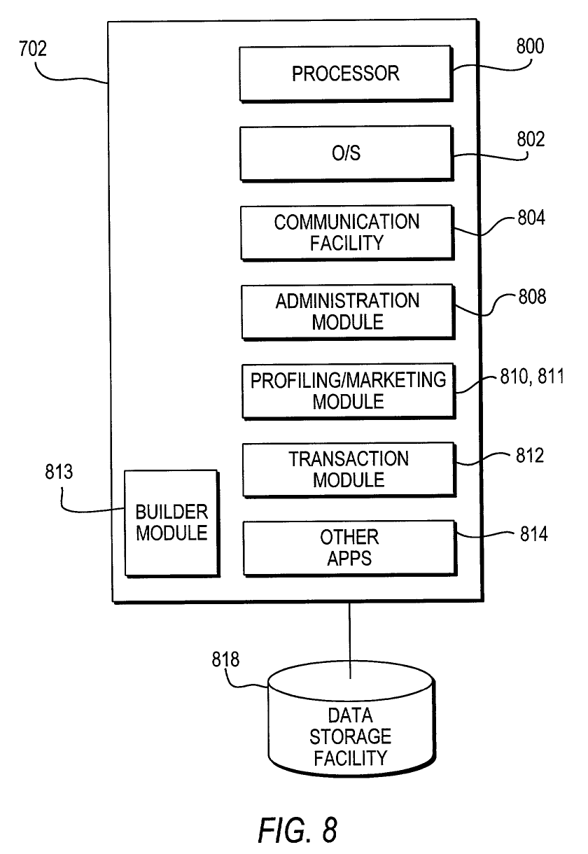

Referring to FIG. 8, further details of hardware and software components of the host system 702 are provided in a schematic diagram. The host system 702 may comprise a server or other conventional computer system that is capable of performing the functions described herein. In embodiments, the host system 702 may include a primary server and a second terminology server for serving pages relevant to use of specialized terminology sets as described further below. In an embodiment the host system 702 may include a processor 800, which may be a Pentium-based processor, Celeron processor, or other suitable processor for performing computing functions. The system 702 may further include an operating system 802 operating in conjunction with the processor, which may be a Unix, Linux, Windows, Mac, or similar operating system that is capable of supporting a graphical user interface and one or more applications. The system 702 may further include a communication facility 804, which may include hardware, firmware, and software elements for supporting communication between the system 702 and one or more external systems, computers or devices. The communication facility 804 may include software modules, as well as a modem, DSL modem, cable, network card, network interface, or other conventional facilities for allowing the system to connect to an external communication facility, such as a network, such as the Internet. It should be understood that the system could be employed within an institution, such as a large company, via an intranet as well.

The host systems can be any hardware platform suitable for supporting web-based interactions, such as Sun or Unix servers running Windows, Linux, or other conventional operating systems.

The system 702 may further include various software modules for performing functions described elsewhere herein. For example, the system 702 may include an administration module 808 for handling registration of professionals, offices, enterprises, other content providers and other entities, and for maintaining and facilitation modification of that data, as well as performing other administrative functions described herein. The system 702 may further include a profiling module 810, for handling profiling functions described herein in conjunction with the administration module 810 or independently, such as profiling service requesters, service providers, enterprises, other content providers, and other entities. The system 702 may further include a matching module 811, for handling functions related to matching of a service requester or a particular request with a service provider. Further details of these functions are set out below. The system 702 may further include a transaction module 812 for supporting transactions, including financial transactions as well exchange of services and knowledge. Further details of the transaction module 812 and functions performed by it are set out below. The system may also include a builder module 813, which may be an envelope builder application enabling professionals to use their basic professional profile for creating detailed business offerings incorporating complementary knowledge items as well as personalized settings and preferences. The builder module 813 can support the creation and centralized operation of multiple views (e.g., cyber-office views) with segmented, differentiated offerings, such as to allow a professional to interact with or within more than one different enterprise 2004. The system 702 may include various other applications 814 for performing conventional computing functions and for performing the functions described herein. The system may also include an internal or external data storage facility 818, such as a database, for storing programs, as well as data relevant to the various entities, such as professionals, offices, other content providers, enterprises and other entities, who participate in the system. Data for the system 702 may be stored centrally in the data storage facility 818 or may be stored in multiple locations, including local storage of certain information. The data storage facility, which may be a Microsoft SQL Server, Oracle, or similar facility, may also store the terminology data sets for implementing terminology-based functions described below.

In one preferred embodiment, the software modules can be coded in a platform-independent language, such as JAVA, or using an object-oriented language such as C++.

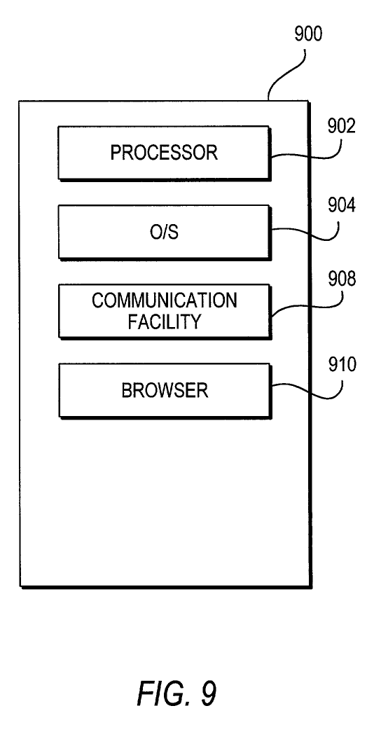

Referring to FIG. 9, a high-level schematic diagram 900 sets out components that may be appropriate for an enterprise system 704, office system 708 or a professional system 710. Each of these systems may be a conventional computer system used for multiple purposes, one of which is to communicate and interact with the host system 702. Such a system may include a processor 902, an operating system 904, a communication facility 908 and a software facility, such as a browser 910, for facilitating access to the host system 702 via a network, such as the Internet.

Just as an enterprise must register and profile itself within the overall marketplace of the host 2002, a professional can create a virtual presence that captures a multi-dimensional, unique set of skills, proficiencies, and characteristics. In embodiments, this is accomplished using controlled intra-industry terminology datasets. Thus, a profiler application of the enterprise serves as a classification tool for defining and maintaining the professional's identity, knowledge characteristics, and inter-relations of the same, using structured terminology. Associated with the profiler application may be a builder application that serves as an envelope to allow a professional to develop a more elaborate and descriptive business offering, as well as tools to create and manage different views of the professional with different business offerings, each associated with a different enterprise.

In an embodiment, the system supports a method of providing a marketplace for a professional service. First, the system establishes a facility for permitting a service provider to digitally present a service offering that it wishes to provide through the marketplace. To make this service offering more useful, the system also establishes or uses a hierarchy of the types of services that are provided in the profession of the service provider and either establishes or uses a semantic terminology for describing the types of services provided in the profession of the service provider. Then, the system establishes a profile-building module for assisting the service provider in creating a service description that uses the semantic terminology and that positions the service offering in the hierarchy.

The profiling module 810 enables a professional 2010 to structurally classify expertise and other characteristics to serve as building blocks for the professional's electronic/cyber/online presence in the marketplace and for the professional's participation in knowledge exchange transactions. Once properly profiled and placed within the hierarchy using the structured terminology, it is possible to conveniently match a professional with a service request (and thus, in effect, the service requester who posted that request). The providers may be matched in list that is displayed to the service requester. As a simple example, if the professional is an attorney, the hierarchy might require the attorney to register in a speciality (e.g., litigation), which might be divided into further sub-specialties (class-action litigation), and even further sub-specialties (product liability class-action litigation). Then, if a service requester has a product liability complaint, it would be appropriate to consider matching the two. The semantic rules assist in the classification by selecting appropriate terms where multiple terms may apply, and by recognizing and relating synonyms. For example, the system may treat the term “attorney” as equivalent to “lawyer” and term “litigation” as equivalent to “trial.”

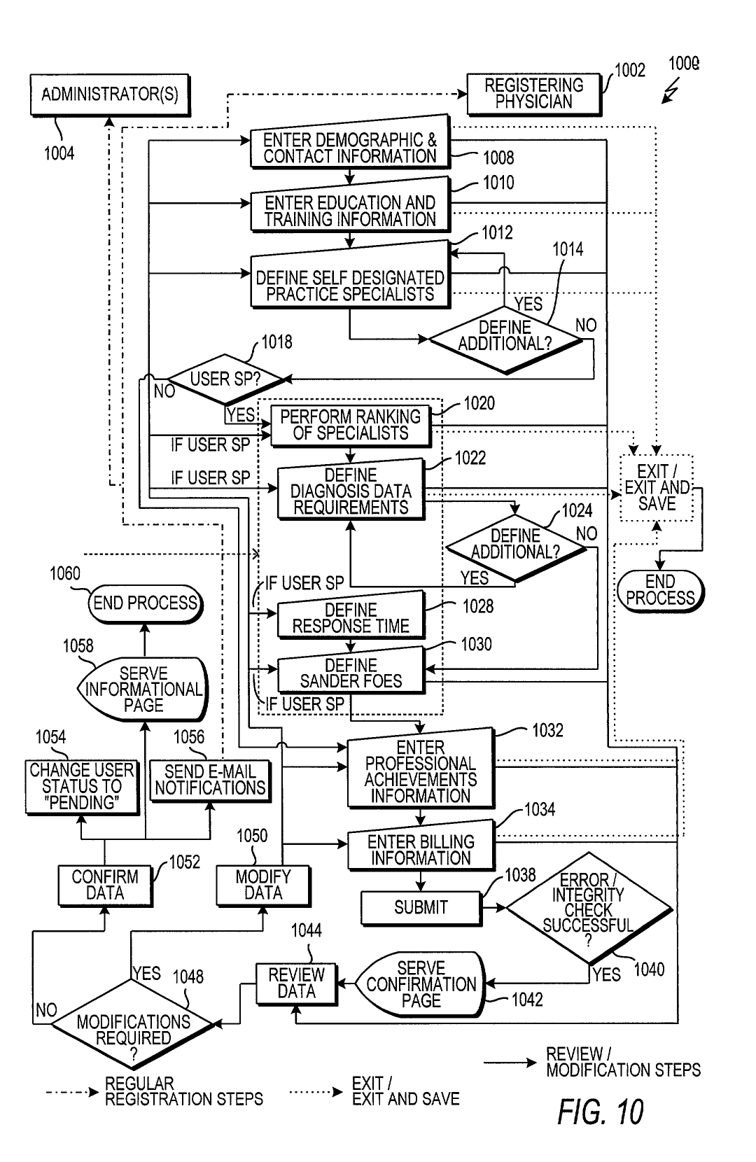

The operation of the profiling module 810 begins with a profiling process for an enterprise, which may be managed by an administrator (such as a colony administrator in a health care embodiment) through a manager view of the assets that he or she is managing for the enterprise. Referring to FIG. 10, a flow diagram 1000 sets out the high-level steps for an embodiment of a registration process to facilitate profiling of service providers. (Note that the process is nearly identical for service requesters (who may also be service providers some of the time), except that service requesters may not be required to enter all fields, such as those related to data requirements necessary to provide services). The steps for profiling a service providers are accomplished with actions by a registering professional 1002, who might be a physician, lawyer, engineer, accountant, nurse, consultant, paralegal, auditor, or other professional, and by an administrator 1004, who operates on behalf of the host of the host system 704. It should be noted that upon completion of any of the steps of the flow diagram 1000, it is possible for a professional 1002 to exit and save the information that is entered up to the point, so that the professional 1002 can start again without having to reenter information that was already entered.

Referring still to FIG. 10, at a step 1008 the registering professional enters basic demographic and contact information, such as name, address, email address, age, employer, phone number, fax number and the like. At a step 1010, the registering professional 1002 enters background information, such as information about education, degrees, training, institutions attended, memberships in associations, certifications obtained (e.g., specialty or board certification), publications, and other information pertinent to the professional's abilities. At a step 1012, the professional 1002 defines his or her practice specialties and sub-specialties. In different embodiments, the steps 1010 through 1012 might be performed in a different order, but in a preferred embodiment are performed in the depicted order. At a step 1014 a professional is given an opportunity to define additional specialties or subspecialties by returning to the step 1012. If the opportunity is declined, such as upon completion of entry of all specialties and sub-specialties, then at a step 1018 the professional 1002 is queried whether the professional 1002 wishes to provide services, i.e., to be a service provider in the system 702. If not, then the professional 1002 is sent to a step 1032, where the professional is prompted to enter professional achievement information as a service requester only.

If the professional 1002 wishes to be a service provider, then the professional is handed to a step 1020, where the professional 1002 is asked to perform a ranking of specialties. It should be noted that the ranking may be different for different offices of the professional. For example, a lawyer might rank copyright cases as the preferred specialty for an office or view dedicated to pro bono work for artists, but might specify patent cases as the preferred specialty for an office or view dedicated to private practice.

Next, at a step 1022, the professional 1002 is asked to define the data requirements that the professional 1002 would require or desire in order to perform a service of one of the types that professional wishes or is willing to perform. These data requirements also help the system determine whether the services that the professional wishes to provide are likely to be applicable for a given service requester and service request. For example, if the professional 1002 is a physician, then the physician would define what data the physician needs or wants in order to perform a service. If the professional 1002 is an attorney, then the attorney would define what data is needed to provide a legal consultation, such as determining whether the matter in question must be handled in a jurisdiction where the attorney is registered to practice law. At a step 1024, the professional is prompted to determine whether more data requirements need to be defined. If so, then the professional 1002 returns to the step 1022 and repeats this loop until all data requirements are entered. Data requirements may be mandatory, thus required in order for the professional to be required to perform service, or they may be optional, with their absence having the possibility, but not necessity, of causing a transaction to be rejected. For example, a personal injury attorney might require an x-ray for handling a broken bone case, or might make that an optional requirement, or a medical professional might require, or just desired, an MRI for the patient before agreeing to the consultation.

A purpose of the diagnostic data requirements is to minimize any unnecessary back and forth between requester and provider. The professional outlines the minimal data set in order to respond to a case completely right away. For example, a medical professional may have a set of standard tests, such as X-ray, EKG, blood tests and the like, (all structured using the required terminology) before the professional can give a service. The professional specifies at what level of requirement he or she wants for a given item of data. For example, for optional items the professional is willing to accept a request without it, but because it is missing, that might serve as grounds for rejection of the request. The data requirements are integrated into the matching process and service request process and can be changed for other systems. The system is designed to reduce reasons for rejection by filtering through the data requirements, response times, case loads, and other potential bases for rejection. Each case finds someone who is suitable, has relevant information, has availability, and the like.

When all data requirements are entered, the professional 1002 proceeds to the step 1028, where the professional 1002 defines the response time that the professional 1002 expects to achieve in meeting service requests. For example, an engineer professional 1002 might indicate that she will respond to queries within 48 hours, or for non-emergency situations within two or more weeks. The administrator for a given enterprise or sub-enterprise can later use these response times to help monitor performance and send alerts as response times are approached without appropriate action. Next, at a step 1030, the professional 1002 defines fees for the services that the professional 1002 will provide, such as hourly fees, transaction-based fees, contingency fees, time and materials fees, and other fees.

When a service provider professional 1002 has completed the steps 1020 through 1030 (which, in different embodiments, may be set out in any order), the professional 1002 proceeds to the step 1032 (the same step at which a non-service provider professional 1002 arrives upon completion of the steps 1008 through 1014. At the step 1032, the professional 1002 enters professional achievement information, such as certifications obtained, research interests, awards and honors, memberships, publications, and the like (to the extent not already entered in the step 1010). Next, at the step 1034, the professional 1002 enters billing information, such as the billing entity and address for the professional's practice. Billing information might be for an office, enterprise, or other entity, or for the individual professional 1002. Next, at a step 1038, the professional is asked to submit the information to the administrator 1004. A check is then performed by the profiling module 810 of the system 702 at a step 1040 to determine the completeness and integrity of the data submitted. If there is a problem, an error message is sent to the administrator 1004 and/or the professional 1002 is prompted to complete any incomplete or erroneously completed steps, then returned to the step 1040.

Once integrity is confirmed at the step 1040, the system services a confirmation to the professional 1002, conforming completion of the registration and profiling entry process. Next, at a step 1044, the administrator 1004, or an automated process of the system 702, reviews the data. At a step 1048 the system determines whether modifications are required. If so, then at a step 1050 a message is sent to the professional 1002 or the administrator 1004, where appropriate, asking him or her to modify the data If no modifications are a required at the step 1048, then at a step 1052 the system confirms the data, storing it in the data storage facility 818, sending an email at a step 1056 to the administrator 1004, and at a step 1054 changing the professional 1002 to a status of “pending” in the system 702. Next, at a step 1058, the professional 1002 is served with an information page introducing aspects of the system, and the process is completed at a step 1060.

Thus, the professional, once registered, has created a working environment to receive problems or cases that match a set of required or desired requirements. The professional has created an existence and profile with a community that can now recognize the professional as having particular expertise and desires, in each case using structured terminology that allow useful comparisons between different physicians, such as those from different countries that otherwise use different words for the same things. The professional may also be provided with a variety of software tools to facilitate participation in the community, such as administration tools (for scheduling, providing paging information, tracking status of open, closed and denied requests, tracking the number of open cases against the maximum the professional indicates he or she is willing to accept, managing different office views, and the like); tools for handling information related to the profession (such as database tools, search tools, and the like), for example a database storing the publications that the professional refers to often in performing services; and tools for handling actual service requests for the relationship, problem or condition the professional wishes to service. In embodiments, these tools may drive the professional to enter data according to structured terminology for the profession, improving the likelihood that a proper match and proper service will be provided across borders despite regional or national differences in terminology. In other embodiments data may be entered as free text.

A professionals registered in the system registers as an individual professional via an office. However, many professionals may wish to establish an office and associate with an enterprise or sub-enterprise, which may include one or more professionals. An office may be an online/cyber presence that is designed to facilitate interaction of the professional with enterprises (and including sub-enterprises) within the host system, according to the rules of the particular enterprises. Among other things, an office allows a professional to market a profile-based description of the professional's intellectual capital to potential service requesters, to help potential service requesters find the most appropriate professionals, to allow service requesters and providers to efficiently conduct exchange of intellectual capital-based services, and to establish integrated support utilities and tools to allow for effective management of an electronic professional practice.

An office, as described herein is a cyber-, virtual, digital, or online office, which might be given a brand name or type description by the host, such as “TerraOffice.” An office is a personalized, industry-specific, electronic presence created through a profiling process that is described in detail below. The office serves as an interface for the professional to the enterprise system. The enterprise system can serve as a data repository. The office enables the professional to exchanged profile-based intra-industry knowledge services and products with other offices and other entities that interact with or within the host system 702. The office can feature other functions and features to support the exchange of intellectual capital, such as decision support tools and the like. An office serves as a professional's cyber office, allowing the professional to exchange (buy or sell) intellectual capital-based, electronically exchangeable services and products. The office can also provide integrated, configurable, management and communication functionalities designed to furnish the professional with the ability to operate and manage the cyber-office in an efficient manner (e.g., integration of pulling of knowledge from relevant sources, configurable event-triggered notifications, messaging and collaboration facilities, registration and management of assistants and employees, integrated reporting utilities, decision support tools, and other functions).

A given professional can register with any number of enterprises, through multiple offices having different “views.” The individual can have multiple views, each represented by a different office, each office representing a different mix of intellectual capital-based services or products. Registering with different enterprises thus allows segmentation of services. The registration and profiling of an individual professional can happen with a variety of processes, depending on the rules of a parent entity, with the variations including, without limitation, service pricing, response time, pre-consultation requirements, and service preference domains. An enterprise can support an unlimited number of offices, or can set a limit. An professional can have both enterprise views (operating within enterprise rules) and non-enterprise, or independent, views that do not require compliance with rules of an enterprise. In some cases, a professional may only wish to acquire, but not provide services. In other cases, the office may be for a service provider. In some cases, an individual is both a service requester and service provider. All offices must follow governing rules of the host marketplace. Those operating with or within enterprises must also follow additional enterprise rules. Offices can be managed by an administrator. The administrator may or may not be a professional who provides services via the office.

Participation of a professional within the host marketplace begins with a profiling process. The profile for an enterprise is built by the system based on the profile information for the professionals who have offices affiliated with that enterprise, which was entered at the professional registration process, such as that described in connection with FIG. 10. For a sub-enterprise or enterprise, the process allows aggregation of the specialties, sets of expertise, and the like from those entered for each professional, to represent the collective intellectual capital of the enterprise or sub-enterprise. Thus, the system can automatically generate a view for an individual professional based on the registration of a professional and an indication that the professional wishes to join the enterprise. Once a view for a professional is established, it can be maintained by a profile administration process.

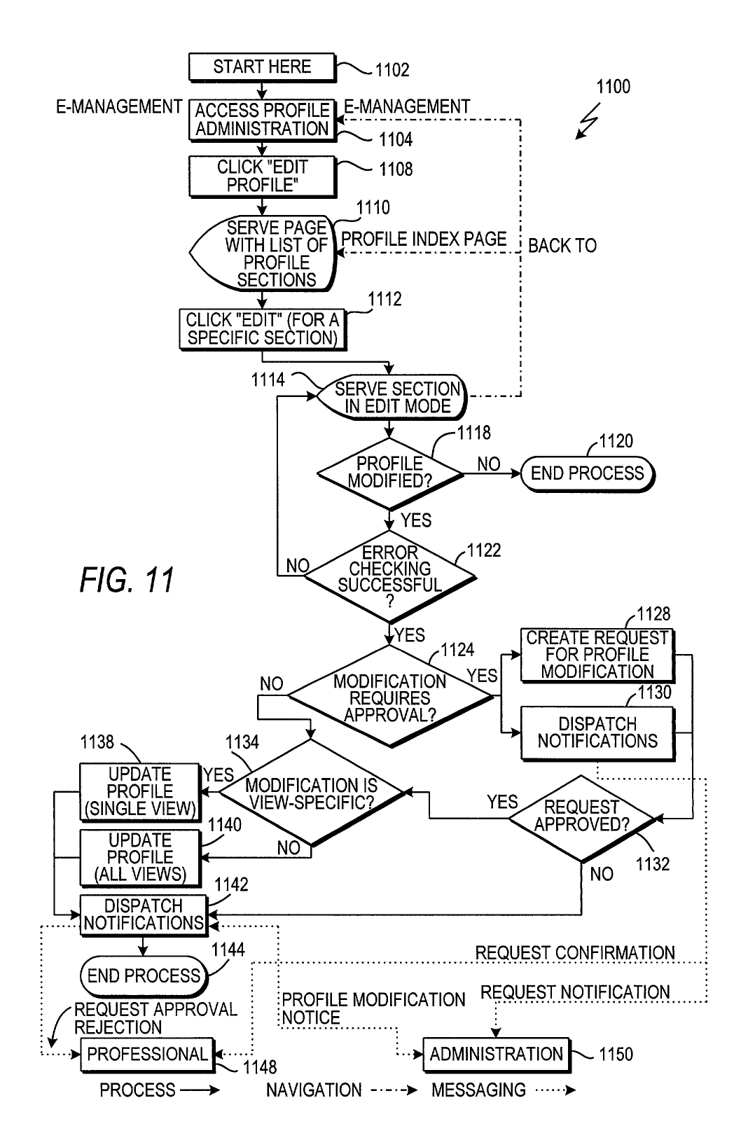

Referring to FIG. 11, a flow diagram 1100 sets out steps for a profile administration process for an office of the host marketplace. The process starts at a step 1102. At a step 1104 an administrator for the office accesses a profile administration tool, which may be a web-based interface accessible through a browser. At a step 1108 the administrator elects to edit the profile of the office, such as by clicking an “edit profile” button of the interface. At a step 1110, the system can serve a page with a list of the profile sections for the office. At a step 1112 the user can click an indication of a desire to edit for a given section, such as by clicking an “edit” button next to an indicator for the section of the profile. Next, at a step 1114 the system can serve the section in question to the administrator in an edit mode, where the administrator can edit the profile. At a step 1118 the system determines whether the profile was modified. If not, then the process ends at a step 1120. If there is an edit, then the system checks for errors at a step 1122. If errors are found, the page is served again at the step 1114 for correction. If there are not errors, then the system determines whether the edit is of the type that requires approval at a step 1124.

In embodiments the profile process for an office may be built partially based on entered data, such as, in the health care embodiment, based on the subject matter of residencies and fellowships the professional has worked in. In a terminology-driven embodiment, the professional selects from a list that comes from a terminology server for that profession. Some sections of the list may allow the professional to drill down to sub-specialty preferences. In embodiments, an enterprise or sub-enterprise may allow customized preferences outside the terminology sets. The preferences entered may be varied depending on the office view that the professional is setting up. Thus, preferences may be expressed one way for affiliation with an enterprise and another way for affiliation with another enterprise or for unaffiliated presence in the marketplace.

Where terminology sets are used, the system can take advantage of known hierarchies in tracking specialties. For example, the system knows that a “female urologist” is also a general urologist, but prefers female urology. In embodiments, many different terminology sets can be used, such as health care set, a medical set, a surgical set, a legal set, an engineering set, an accounting set, a manufacturing set, a science set, a biology set, a chemistry set, a physics set, a mathematics set, an economics set, a language set, a linguistics set, a consulting set, a business set, a biotechnology set, a telecommunications set, a computer language set, a computer science set, a research set, and a corporate set.

The preference process allows the professional to specify the preferred conditions and procedures the professional wants to deal with. For example, the professional might be an internist who specializes in congestive heart failure, chronic prostatitis, or another condition. By ranking preferences, the professional can specify at any time (and modify), whether he or she wants cases, is merely willing to accept them, or declines them, across the various conditions and procedures, by indicating “Preferred”, “Accepted”, and “Declined” in a software field for each of the areas where the professional has abilities. The professional can always change it by modifying the view. The view can be unique to the office in question (e.g., if the professional is at a Columbia University clinic for congestive heart failure that view might only accept heart failure cases, while a private office view might accept other things as well).

Referring back to FIG. 11, if an edit to a profile requires approval, then the system creates a request for profile modification at a step 1128 and sends notifications at a step 1130 to parties whose approval and/or notification is required. Such approval might come from an assigned administrator, who might be a professional within the office, an individual within an enterprise, or an individual within the host. Next, at a step 1132 it is determined whether the request is approved. If not, then notifications are sent at a step 1142, and the process ends at a step 1144.

If at the step 1124 the edit is of a type that does not require approval, then at a step 1134 the system determines whether the modification is specific to particular view of the profile. If so, then at a step 1138 the system updates that particular view in the profile. If at the step 1134 it is determined that the modification is not view-specific, then at a step 1140 the profile is updated in all views. Upon completion of either the step 1138 or the step 1140, resulting in updating of either a single view or all views, then at a step 1142 notifications of the changes are dispatched to appropriate professionals 1148, administrators 1150, and the like, and the process ends at the step 1144.

Thus, through a profile administration tool and other views, the administrator for an enterprise or sub-enterprise can track a hierarchy of items that represent the assets of that enterprise or sub-enterprise, such as the specialties and expertise of the offices that affiliate with it, categories of conditions or problems treated or solved by the enterprise (based on aggregation of the same for all service providers and offices registered with the enterprise or sub-enterprise), and specific conditions or problems addressed by the same. Other administration tools allow the administrator to track work-flow items, such as the number of problems or cases handled, status items for 110 cases (open, closed, denied), response times to queries, and the like. The administrator can, by managing the profiling process, grant different rights and relationships to each service provider and each service requester in the marketplace. Each of them once registered, may access the marketplace through a software application that facilitates interaction, as described below.

Once professionals, offices, enterprises and other entities are established in the marketplace, it is possible for them to interact and transact service requests and the provision of services. For a service requester, a request process guides the service requester through a process of defining the service requester's issue, optionally according to the hierarchy and semantic terminology that is established by the host for the particular marketplace in question. The requester also must enter the data necessary for matching the service request and one or more service providers, and may also enter data that is ultimately used by a service provider in performing a service on behalf of the service requester. Thus, the transaction module 812 of the host system 702 may enable various functions of a request process.

The transaction module 812 may be an integrated workflow software application that facilitates the exchange of intellectual capital- or knowledge-based services and products between trading parties. Like other modules disclosed herein, it is preferably coded in an object-oriented language such as C++, optionally a platform-independent one such as Java. The transaction module 812 may support the formation of a business agreement between potential service requesters and service providers. The transaction module 812 may support a point-to-point, multi-cycled, structured and manageable exchange process between a knowledge seeker and a subject expert. The high-level elements of the transaction module 812 are a service request (which may request service from a single professional, or from multiple professionals (e.g., a grand round in the medical profession)), a matching process, a pre-consultation process, a contract formation process, and a consultation process. These processes are supported by the underlying hierarchies and terminologies of the system, as they apply in the particular professional area in question.

In an embodiment, a service request is a structured, customized, terminology-based data entry process enabling professionals to clearly define the domain and nature of the required service or product. Within any particular professional environment, there may be many different types of service requests. Thus, the system can enable a structured data entry process aimed at clearly defining the topic of the question using standardized terminology. The system can also provide structured tools to provide a description of the issue and state the expected nature of the answer within a selected type of service request. The system can also append supplementary, requester-defined attachments for the benefit of prospective service providers. Basic kinds of requests may vary. In health care, three basic requests include a request for a second opinion, a request for treatment, and a request for a grand round, or joint consultation by multiple experts. The grand round may be initiated by a service requester or by a service provider who subsequently takes on a requester role in order to engage other professionals to complete a consultation. Other requests may include a request for non-clinical services, such as review of an x-ray, pathology slide, or the like.

In an embodiment, a service request is unique for a given professional and is transmitted anonymously, without the patient name and contact information. In some cases personal information of the patient may be relevant to the consult and required, such as for diagnosis of illnesses where there are differences between ethnic groups. Information is thus stored with the professional for the consult, who can share the information through a subsequent request with other professionals.

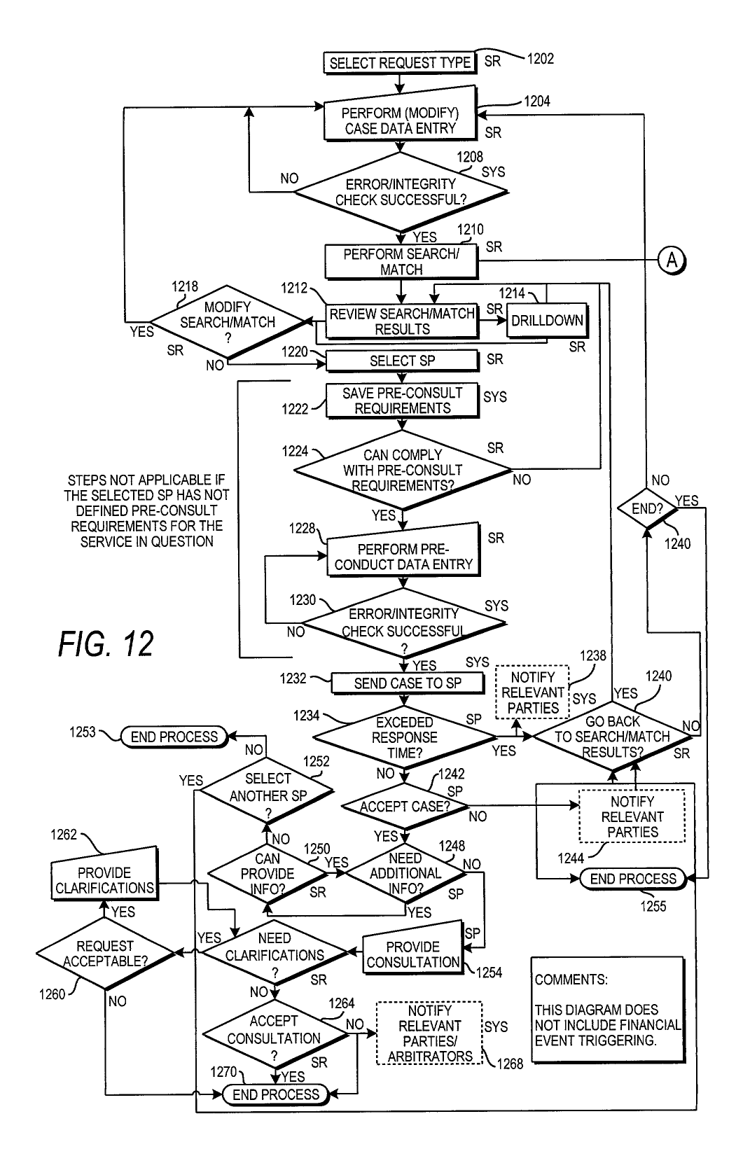

Referring to FIG. 12, a flow diagram 1200 sets out the steps by which a transaction process provides for a consultation (i.e., the provision of a service by a service provider to a service requester, after the service requester has entered the system looking for help.) First, at a step 1202, a service requester selects a type of request from a menu of possible requests. For example, if the service requester is interacting in a medical domain, the request might be for a diagnosis. Alternatively, it might be for selection of treatment. If the domain is accounting, the service requester might be seeking tax advice, or might be seeking advice on an accounting issue. Using standardized terminology, any profession's services can be set out in a hierarchy that allows a service requester to find a type of request at the step 1202.

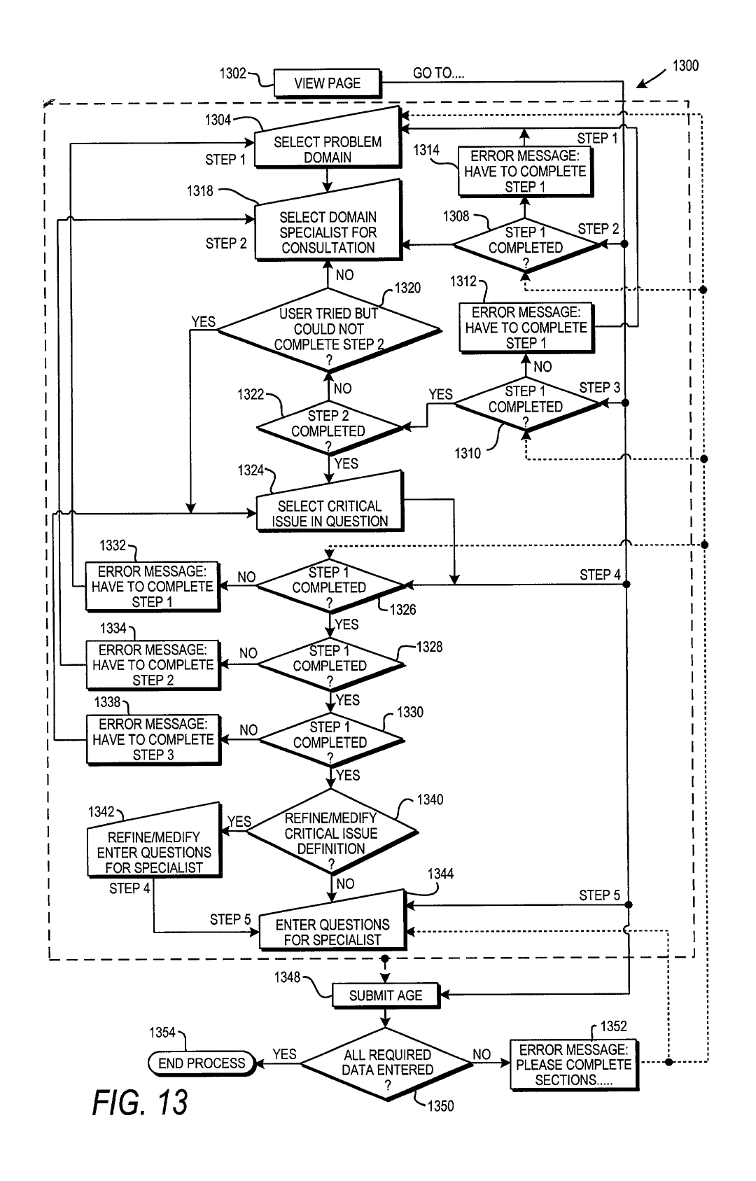

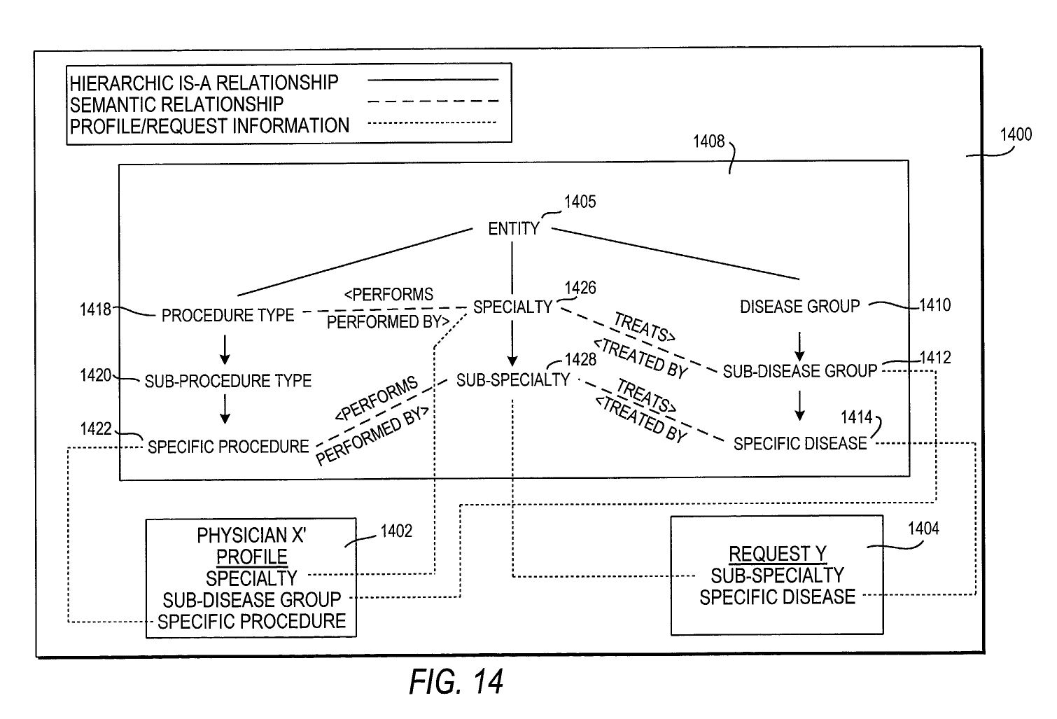

Next, at a step 1204, the service requester is asked to perform data entry (or to modify data, in the case where the service requester has already entered data). The data requirements for the service request in question were established by the host, or by enterprises, offices, or service providers, during the profiling process for service providers, using the semantic terminology of the host for that marketplace. Once the data is entered, an error check occurs at a step 1208, which, if failed, returns the user to the step 1204 to modify the data. For example, some data requirements are mandatory, and, if missing, will result in rejection. Other items may be optional, in which case an alert may be sent, but the service requester may continue with the process, recognizing that absence of optional data may negatively impact the process. Once the data is complete and free of errors at the step 1208, then the system performs a match at a step 1210 to find a prospective service provider or providers for the request. Details of the matching process are discussed below in connection with FIG. 13 (connected to FIG. 12 by off-page connector “A”) and FIG. 14. Once a match has been found, the service requester can review the match at a step 1212. The service requester can obtain further details about the service provider at a drilldown step 1214. If not satisfied that the service requester has all information it needs to form a match, the service requester can choose to modify the search at a step 1218, which if selected, returns the requester to the step 1204 to change the data entered at the data entry step to obtain a different search.

If at the step 1218 the service requester does not wish to modify the match, then the service requester selects the service provider at a step 1220. Next, the system retrieves the data requirements that the service provider requires prior to performing a transaction for a service requester and serves them to the service requester at a step 1222. These data requirements are created by the service provider during the profiling and registration processes described above. At a step 1224 the service requester determines whether it can comply with the requirements served at the step 1222. If not, then the service requester is returned to the matching step 1212, to find another match, or to modify the search at the step 1204. The match process can produce multiple choices at the step 1212, so that there may be an alternate service provider from that step, allowing return to the selection step 1220 without further searching or matching.

If at the step 1224 the service requester can comply with the requirements, then at a step 1228 the service requester enters the data required for the service request type in question. An integrity check step 1230 returns the requester to the step 1228 until data is complete and error free. Next, at a step 1232 the system sends the case to the selected service provider. Next, a timing step 1234 waits for acceptance of the case by the service provider, within the time frame indicated in the service provider's registration during the registration and profiling process. If the service provider exceeds the set response time at the step 1234, then the relevant parties (requester, provider, administrator, and any appropriate others), are notified at a step 1238, and the requester is prompted at a step 1240 to choose whether to try another service provider from the previous match results (in which case the requester is sent to the match results at the step 1212), or to modify the search (in which case the requester is sent to the data modification step 1204).

If at the step 1234 the service provider has not exceed the allowed response time, then at a step 1242 the service provider can decide whether to accept the case. In embodiments, the timer may count down the time from the moment of acceptance through the time of submitting the response. If not, then the relevant parties are notified at a step 1244, and the service requester is returned to the step 1240 to decide whether to return to match results or to modification of the search. If the service provider accepts the case at the step 1242, then the service provider is prompted to determine whether it needs additional information at a step 1248. If so, then the service requester is prompted to determine whether it can do so at a step 1250. If so, then the service provider is prompted again at the step 1248 in a loop until all information needed is provided. If at the step 1250 the service requester can't provide the information, then the service requester is asked whether it wishes to select another service provider at a step 1252. If not, processing ends at a step 1253. If so, the service requester is returned to the step 1240 to determine whether to reexamine match results, modify the search, or to end the request at a step 1255.

If at the step 1248 the service provider has all needed information, then at a step 1254 the service provider can provide the service, such as by providing a medical consultation or diagnosis, accounting opinion, legal advice or opinion, digital product, engineering drawing or design, architectural design, design advice, or similar online, cyber, virtual, or electronic, knowledge-based, intellectual capital-based service or product. After the step 1254, the service requester can determine at a step 1258 whether it needs clarification. If so, then the service provider is prompted at a step 1260 to determine whether the request for clarification is acceptable. If so, then at a step 1262 the service provider provides the clarifications, and the service requester is given another opportunity at the step 1258 to review the output and ask for further clarifications. Once the service requester does not require further clarifications at the step 1258, then at a step 1264 the service requester is prompted to accept the consultation. Acceptance of the consultation at the step 1264 ends the consultation process, which may optionally trigger a financial transaction among the service provider and service requester, or which may end processing at a step 1270 (in which case the financial transaction may take place offline, or through a different online process). If the service requester does not accept the consultation at the step 1264, then the system notifies various parties at the step 1268, including arbitrators, or the like.

In an embodiment, a service request may require multi-dimensional expert knowledge from a plurality of service providers (similar to grand rounds in the medical profession). In such cases, the system may support a multi-user, centrally managed collaboration process for servicing such requests. The multi-user consulting process offers an integrated, centrally managed exchange process between a single service requester and multiple service providers, usually within the same domain. The process may include searching, matching, and selection processes similar to those described in connection with FIG. 12, except the requirements definition may further require the selection of one or more additional service providers before service provision is initiated. In addition, collaboration tools may be provided to the service providers to allow them to interact and provide ajointly provided service. The request can be a one-to-many request, or may be a one-to-one request where the service provider needs to consult an additional party, such as by making its own request of a specialist for a particular issue. For example, a transactional attorney who is providing advice on a financial deal may wish to consult a tax attorney for tax advice on a particular aspect of the transaction. The additional request could follow the request process of FIG. 12, or a similar process. The multi-user process supports a one-to-many knowledge exchange process and supports collaboration among multiple knowledge providers to structurally facilitate a one-to-many knowledge request.

The match process initiated by the step 1210 of the flow diagram 1200 of FIG. 12 initiates a more complex process that identifies a list of potential service providers in response to the data entered by the requester that classifies the request as being of a particular type within a particular domain. The matching process improves the expert search process by assisting knowledge seekers in locating and selecting the most suitable subject experts for furnishing a service request within any marketplace domain.

A matching module 811 of the host system 702 performs matching functions described herein. The matching module 811 is an engine employing an algorithmic approach to solve the problem of locating the most suitable subject experts that can service the knowledge needs of specific knowledge seekers regarding specific problems, methods, and solutions, within a given domain. The matching module 811 can locate directly matching providers or identify the most suitable available providers by using expansion algorithms exploiting the hierarchic and semantic data structures of the host system in conjunction with case-specific parameters and the applicable service provider base. Thus, the matching module 8181 incorporates available providers, affiliation-related business rules, and request-related professional and administrative parameters to locate matching, or nearly matching, subject matter experts.

Further details of the matching module 811 are as follows. The matching module 811 locates and ranks suitable experts by employing expansion algorithms using profession-related classification parameters and hierarchical and semantic classification structures and language. The matching module 811 may support allocation of different relative weights of identical parameters within different request types through a graphical user interface with administrative functionality. For example, for a request of a designated type “A”, the weight of parameters X1 and X2 may be set as 25% and 75%, respectively. For a request of type “B”, the parameters X1 and X2 may be set differently, such as at 35% and 65%. The system may support dynamic recalculation of the relative weights for a given request type within a specific request dimension (i.e., administrative, professional, etc. For example, if a user only uses two of six parameters in making a selection of a service provider, then the weights assigned to those two parameters can be increased, perhaps even eliminating the other four parameters. The system can support allocation of relative weights to different parameters through a graphical user interface administrative facility. For example, the aggregate weight of administrative parameters can be set at a given percentage, and the aggregate weight of professional parameters set at a complementary percentage. The system can support modification of intra-dimension parameter weights and inter-dimension related weights using a graphical user interface administration facility. The system can maintain weight allocation integrity by using an integrity manager to enforce a sum of one hundred percent both within a dimension and between dimensions. The system can enable dynamic addition of administrative match parameters and can enforce reassignment of relative weights for the newly created parameter list. The system can allow dynamic selection and use of the relevant algorithm based on request type. The system can support distance-based score calculations, as opposed to using static or recalculated relative weights. Distance may be considered as the number or type of links that separate between a requested item and an available item based on the hierarchical and/or semantic structure of the terminology for that domain and a designated dimension (e.g., specialty, solutions, etc.). The system can provide access to detailed profile information for the located prospective service providers and can support modification of previously used parameters and recalculation of results.

Referring to FIG. 13, a flow diagram 1300 sets out steps for guiding data entry to support a matching process of the matching module 811. At a step 1302 the requester views a page that facilitates entering data for a service request. At a step 1304, the requester is prompted to select a problem domain. At a step 1318, the requester is prompted to select a domain specialist for consultation. If the user attempts to enter this second step before selecting the problem domain, then at a step 1308 the user is given an error message 1314 requiring the user to complete the domain selection step 1304 before proceeding to the specialist selection step 1318. Once a user completes the step 1318, then at a step 1320 it is asked whether the user tried, but could not complete the step 1318. If so, then the user is allowed to proceed to the step 1324 where the issue in question is selected. If the user did not try, then the user is returned to the step 1318. Next, at a step 1322, it is determined whether the step 1318 was completed. If not, then the requester proceeds to the step 1324. If the user attempts to go to the step 1324 before completing the selection step 1304, then at a step 1310 an error message 1312 requires the user to return to the step 1304.

At the step 1324, the user selects the issue in question. Then at a series of steps 1326, 1328 and 1330, it is determined whether the required previous steps were completed. If not, at any of these steps, an appropriate error message 1332, 1334 or 1338 is given to the requester, and the requester is sent back to the appropriate step. If all previous steps are completed, then at a step 1340 the requester can be asked whether the requester wishes to refine or modify any crucial issue definitions. If the requester needs to do so, then it may enter questions about refining the definitions for a specialist at a step 1342. If not, then the user can proceed directly to entering questions for a specialist at a step 1344. Then, at a step 1348, the requester is prompted to submit the page with the completed information. Then the system determines whether all required data was entered at a step 1350. If not, then an error message returns the requester to the missing data step. If so, then the process is complete at a step 1354.

Referring to FIG. 14, further aspects of the matching process facilitated by the matching module 811 are depicted in a schematic diagram 1400. A professional profile 1402, such as that created by the registration and profiling process described in connection with FIG. 10, has been created, having various attributes, including, optionally, a specialty, a sub-specialty, a domain, a sub-domain, a specific service or process, or the like. Similarly, a request 1404 has been created during the process described in connection with FIG. 12 and FIG. 13, which has been classified as being in a given domain, and perhaps within a category and sub-category within that domain. To facilitate matching of the request and the appropriate provider, the host establishes a hierarchy and vocabulary for each professional domain in the marketplace. The hierarchy may include entities 1405, specialties, 1424 and subspecialties 1428, or similar categories. For each entity 1405, the system may store service/procedure types 1418, sub-types 1420 and specific services and procedures 1422, which may relate to specialties 1424 and subspecialties 1428 by storing whether the entity performs the given procedure type, sub-type, or specific procedure within the specialty or subspecialty. Similarly, the system may store various problem types (e.g., diseases for the medical domain, case types for the legal, or the like), including problem groups 1410, sub-groups 1412, or specific problems 1414. In each case, it is recorded in the hierarchy whether a specialty handles (e.g., treats) or does not handle a sub-group, and whether a sub-specialty handles or does not handle a specific problem. Thus, a relation can be established between a specific problem, subspecialty, and specific procedure or service, and a relation can be established between a sub-group of problems, specialty, and sub-type of procedure or service. From this hierarchy, it can be assessed whether there is a potential match among a service provider, based on the profile, and the request, based on the listed attributes of the request.

The match parameters used for the matching process may optionally come from a structured terminology set. For example, in a medical field, they might include a body system, a specialist, and a complaint that relates to the body system and specialty. In the legal field they might include areas of law, practice areas, and specific problems. The hierarchies allow the matching process to drill down where necessary obtain the closest match possible, based on the positions of the problem, the specialist, and the area of practice. Thus the terminology used in the system is used in profiling to establish levels of connection between requests and potential service providers.

In the medical field, terminology can be used from standard forms for medical admission, such as history of illness, medical history, current medication, allergies, current health status, family history and psychosocial history. The data entry can be guided and structured according to the type of problem, using a customized profile and template for the professional who is seeking the data and using terminology from the terminology sets. In addition to finding a substantive match between the request and the provider based on areas of expertise, the matching process can match based on native language, geographic location, gender, country, availability, case loads, preferred response times and the like.

The system performs a match and returns a matching service provider, based on the closest match. The closeness of a match can be determined by an algorithm, such as one that assigns weights to each of the factors in a match and ranks providers according to the weighted match. The weights can be based on the terminology sets, including by counting nodes in a hierarchy of terminology to determine how close two different terms are within the hierarchy. In other situations the matching can be rule-based, with the process returning a list of providers who satisfy rules that apply for a given problem type.

The marketplace disclosed herein can also provide other support features, such as those that support formation of a legal agreement among the service provider and service requester, including, for example, contractual provisions for financial transactions, insurance, and dispute resolution.

Another process of the host system is a sub-process of the process of FIG. 10, which provides a preliminary step. This preliminary consultation process uses the combination of the requested service category (as related to a profile) and the prospective service provider's parameters associated with that category. The preliminary consultation process is aimed at increasing the efficiency of knowledge exchange processes and provider selection by eliminating unnecessary communication cycles as well as filtering relationships that are likely to fail for predictable reasons. The process uses data entered by the professional during the profiling stage. It allows users to define and describe data set requests necessary for furnishing consultations (providing services) regarding specific problems, methods and solutions before actually receiving requests. It is also a subsequent automated process enforcing submission of the prerequisite data by service requesters seeking consultation.

The preliminary consultation process may include a facility for including other data requirements, such as a mechanism to enable the requester to enter prerequisites for furnishing services. The mechanism may be designed to use a table or matrix of request types and professional profile classifications (i.e., available service and product domains) for each service provider. The process may be used for associating data prerequisites for each item in the matrix. The preliminary consultation process may further provide a tool to designate prerequisite status. For each designed dataset the user (service provider) can specify whether the data is mandatory or optional. Classification of optional data can be done per data category (i.e., all items of type X are mandatory, all items of type Y are optional), for individual items (X1 is mandatory, X2 is optional, etc.), or as a degree of freedom (i.e., the user must complete X percent of all items). The preliminary consultation process may also include a mechanism to identify and display the relevant data requirements and their status to service requesters and subsequently check and enforce data integrity of information entered by service requesters. Upon selecting a service provider (or multiple providers), the module will identify the most relevant profile item (i.e., area of expertise or specialty, solution type, etc.) that was used by the matching module 811 to locate the provider, will serve the service requester with a data entry form containing the relevant data set for the addressed profile item and service type, and will check and enforce the integrity of the information as entered by the prospective service requester.

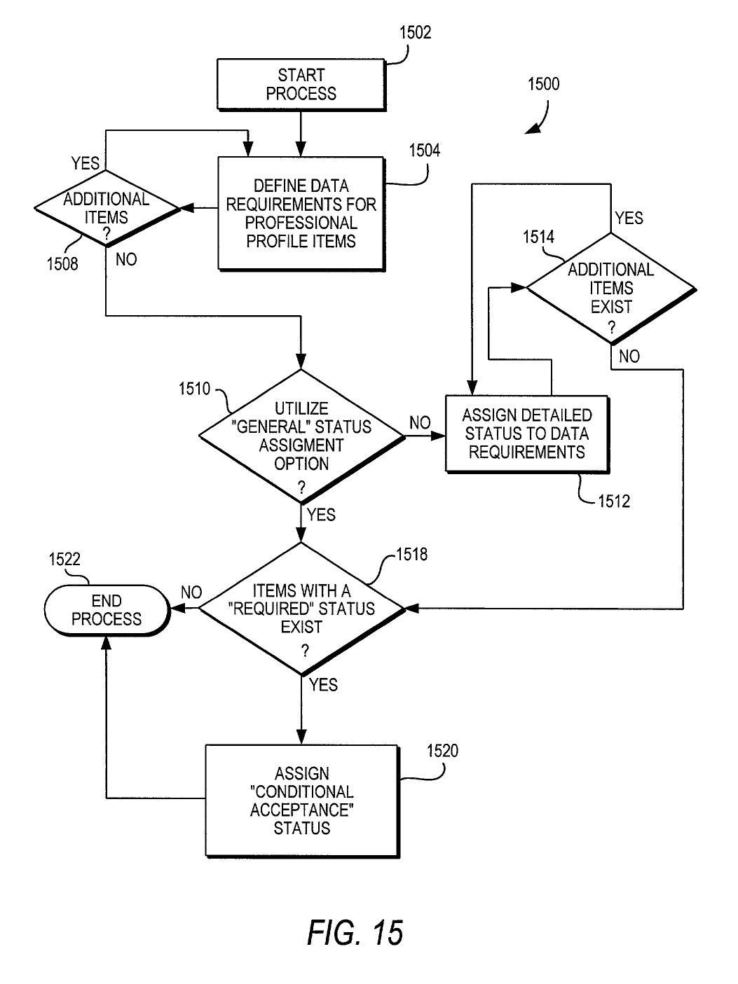

Referring to FIG. 15, a flow diagram 1500 sets out steps by which a service provider can define data requirements necessary for a preliminary or pre-consultation process to take place. First, the process starts at a step 1502. At a step 1504 a service provider defines a data set of requirements for professional profile items. Next, at a step 1508 a query is made whether additional items exist. If so, the loop returns to the step 1504 until no additional items exist. Once no additional items exist at the step 1508, processing proceeds to a step 1510 where it is asked whether the administrator of the process wishes to use the “general” status assignment option. If not, then at a step 1512 the user is prompted to assign detailed status to data requirements at a step 1512. Then the user is queried whether additional items exist at a step 1514 and returned to the step 1512 for assigning status until no such items exist at which point processing is sent to a step 1518, where it is asked whether items with a “required” status exist. This step 1518 is also arrived at if the user indicated that it did wish to use the general status assignment option at the step 1510. If items with a required status exist at the step 1518, then the user may, at a step 1520, assign conditional acceptance status to the items. Then, the process ends at a step 1522, which is also the result if there are no items with required status at the step 1518.

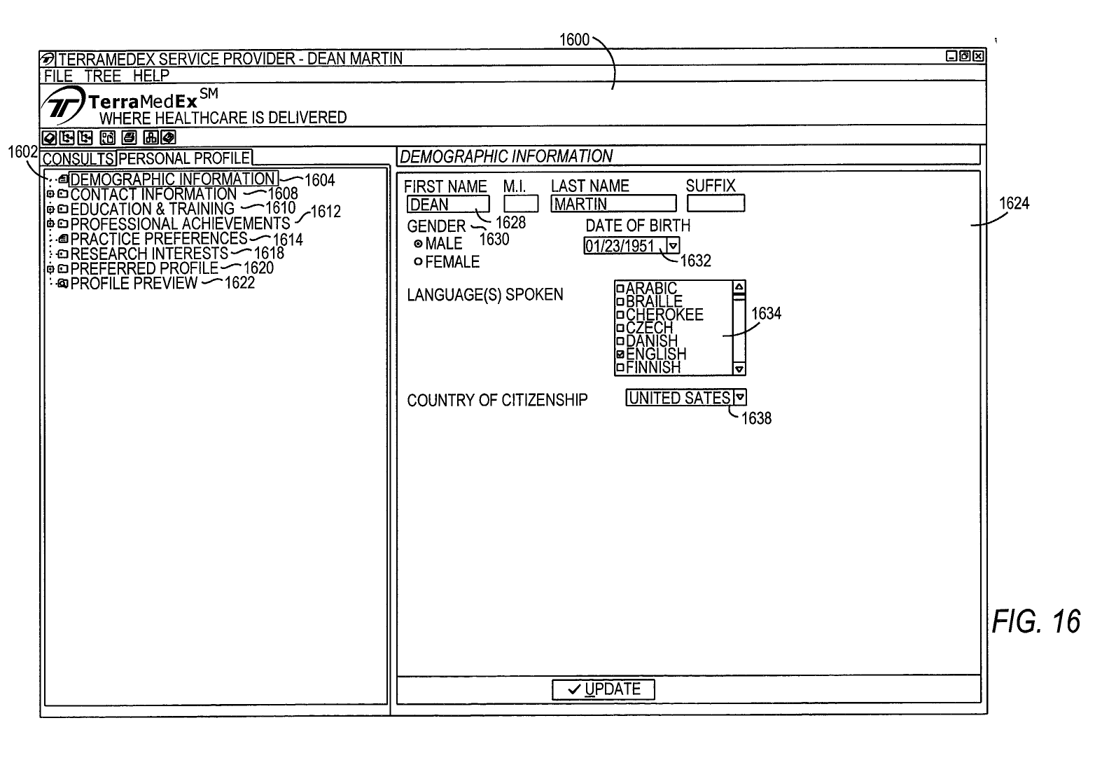

Referring to FIG. 16, a screen display 1600 is depicted for registration of a service provider 2010. The display includes a listing 1602 of various provider information that can be entered into the system and edited to reflect a service provider's qualifications. The listing 1602 includes demographic information 1604, contact information 1608, education and training information 1610, professional achievements 1612, practice preferences 1614, research interests 1618, preferred profile 1620 and profile preview 1622. By clicking on any of items in the listing 1602, the service provider can see further detail. For example, FIG. 16 shows the demographic information 1604 on the right hand portion 1624, including name 1628, gender 1630, date of birth 1632, languages spoken 1634 and citizenship 1638.

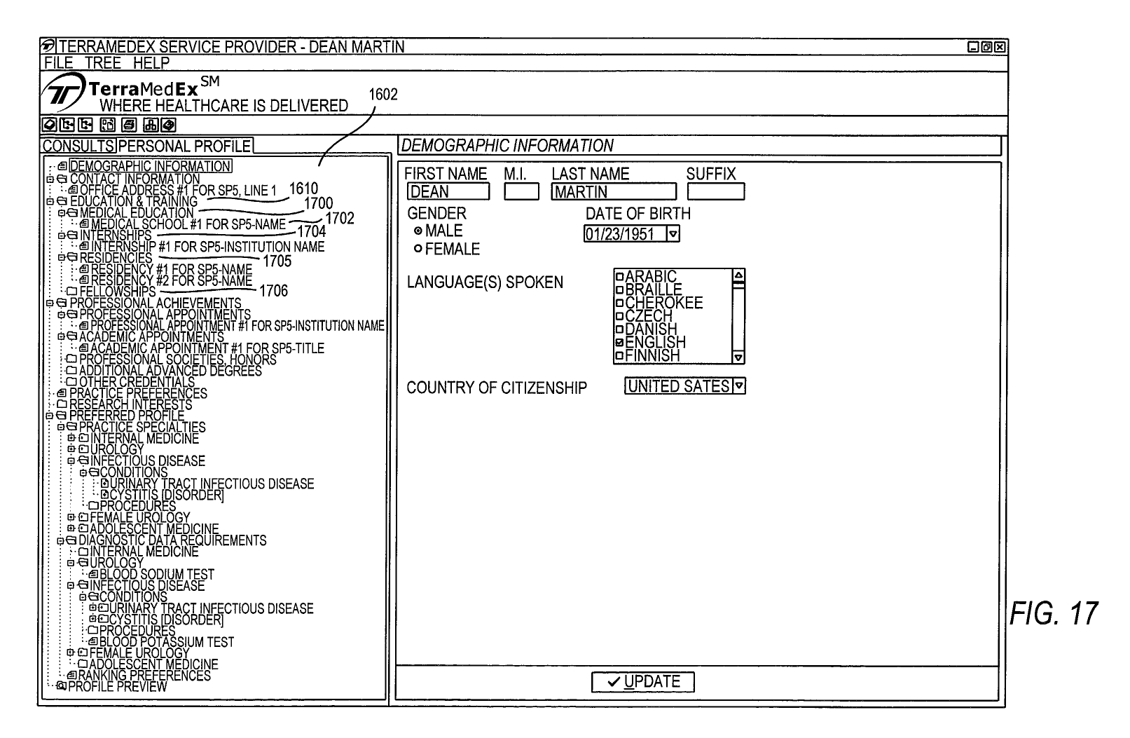

FIG. 17 provides an expanded version of the listing 1602 of FIG. 16. Thus, the listing 1602 may include high-level categories as well as sub-categories for completion by the service provider 2010. For example, the education and training listing 1610 can include medical education 1700, medical schools 1704, internships 1704, residencies 1705 and fellowships 1706. A similar listing could be provided for a non-medical professional, with the categories for the listing drawn from the preferred terminology set for that industry.

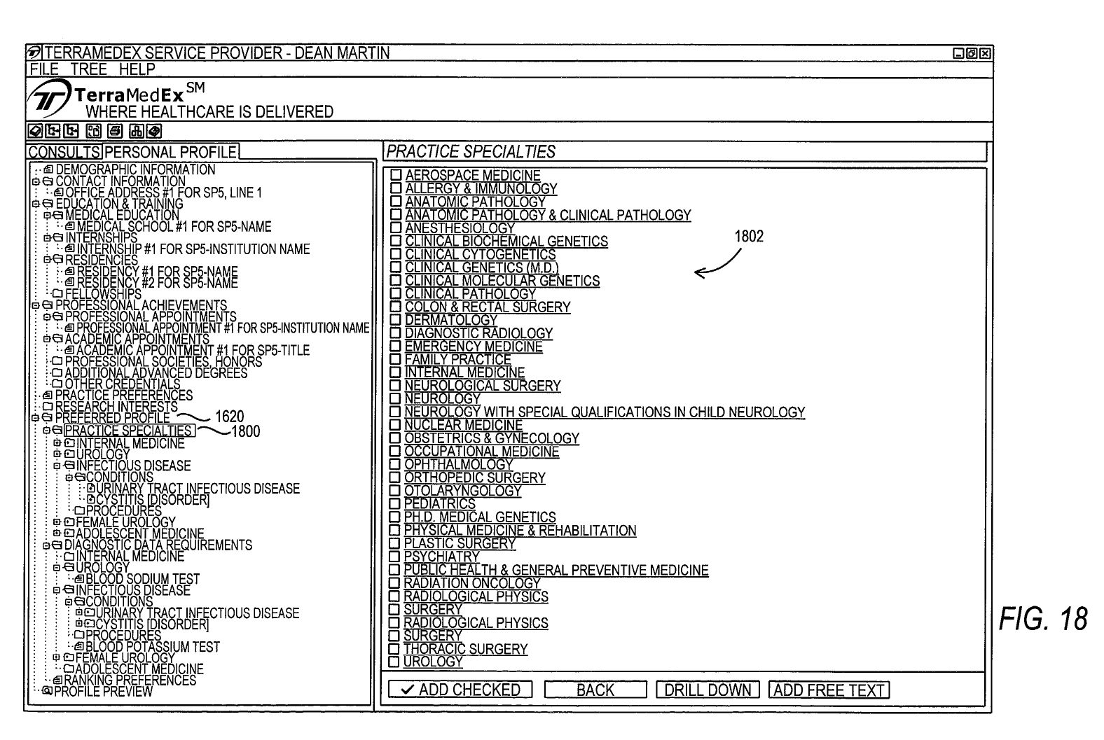

FIG. 18 shows a screen displaying an expanded view of a preferred profile 1620 for a service provider. In this case the professional is a health care professional, and the preferred profile 1620 is expanded to show a variety of practice specialties that are known in the terminology set for health care. The service provider can click on a box in the listing 1802 on the right hand portion of the screen to indicate those practice specialties that the service provider wishes to have included in the profile for that service provider.

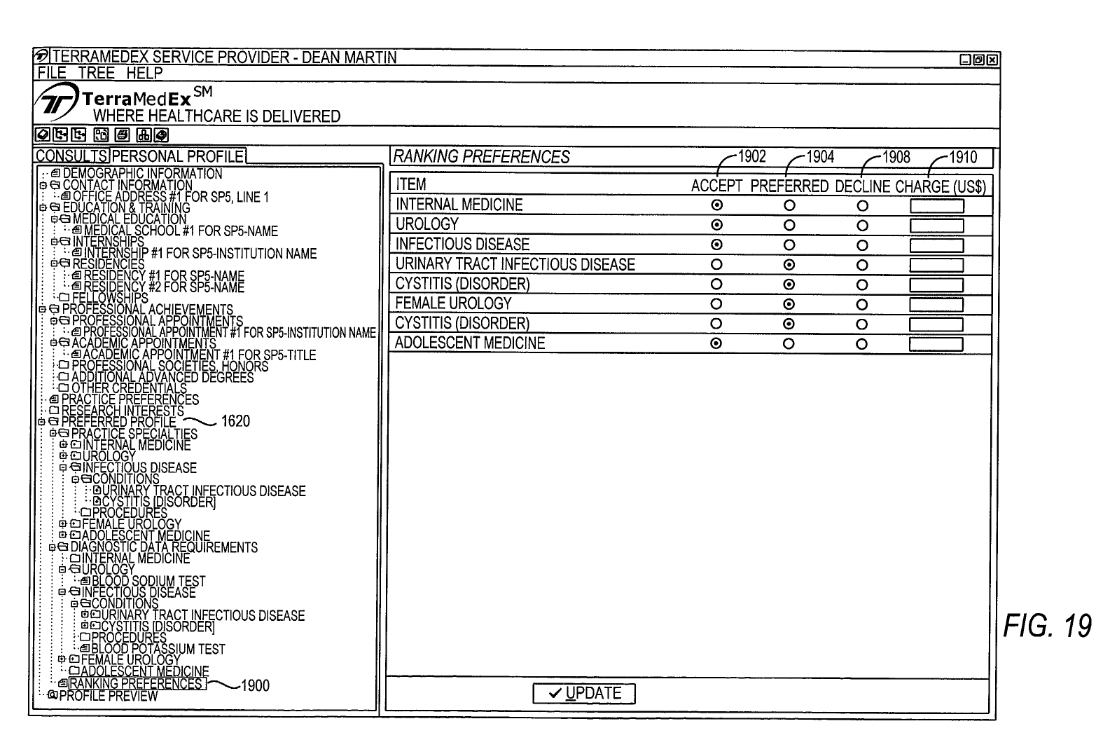

Referring to FIG. 19, a preferred profile 1620 may also be expanded to show a ranking of preferences 1900 for the practice areas that the service provider includes in the list of active practice areas. By clicking in the boxes on the right hand portion of the screen, the service provider can indicate whether it accepts particular types of cases 1902, prefers them 1904, or declines them 1908. The provider can also indicate what it charges for that practice area in a field 1910.

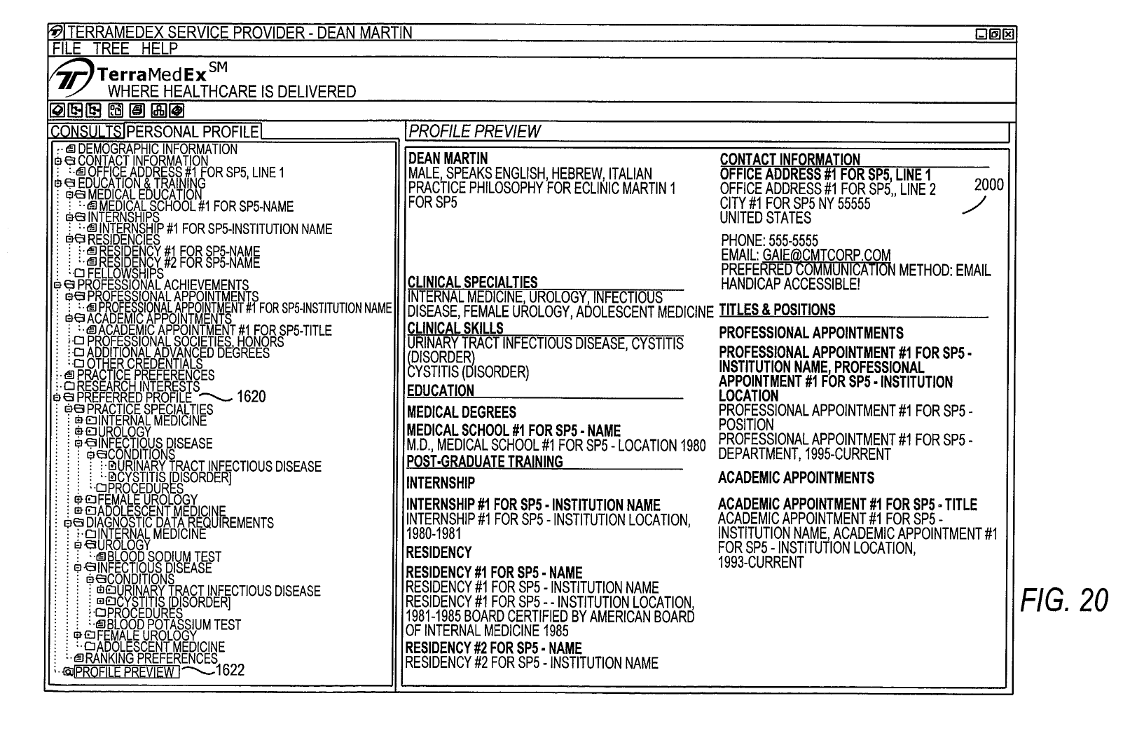

Referring to FIG. 20, by expanding the profile preview field 1622 the service provider 2010 can view a preview of how the professional will be represented in the system. The profile shown in the right hand portion 2000 of the screen depicts important information about the service provider using categories and terminology derived from the specified terminology set for that marketplace, whether it be health care, legal, engineering, scientific, or other.

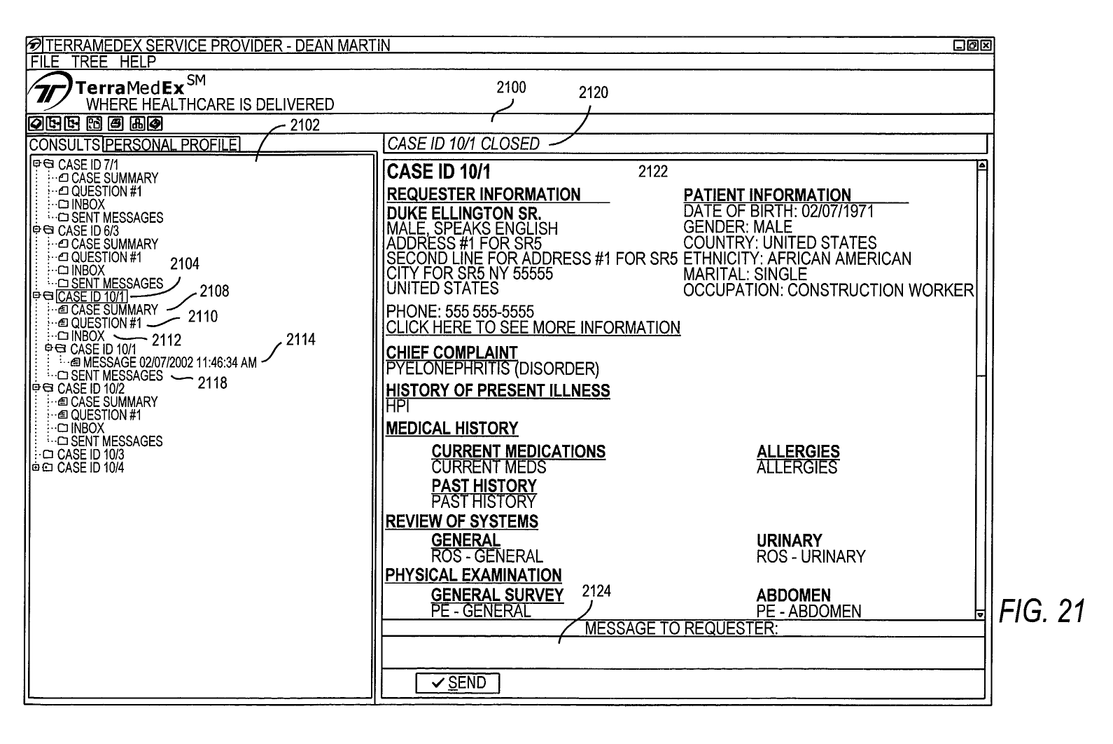

Referring to FIG. 21, a software application for a service provider can also assist the service provider in managing cases in the marketplace. Thus, the application may include a screen 2100 with a listing 2102 of cases the service provider has been asked to handle. By clicking on a particular case 2104, the service provider can obtain information about that case of various types, such as a case summary that can be accessed through a case summary tab 2108, one or more questions that can be accessed through a question tab 2110, incoming messages 2114 that can be accessed through an inbox tab 2112 and outgoing messages that can be accessed through a sent messages tab 2118. When a service provider clicks on the case tab 2104, information for that case appears in the right hand portion 2122 of the screen. A status bar 2120 can indicate the status of the case, whether it be closed, accepted, denied, or the like. The right hand portion of the screen can also have a message box 2124 for allowing the service provider to send a message through the system to the service requester.

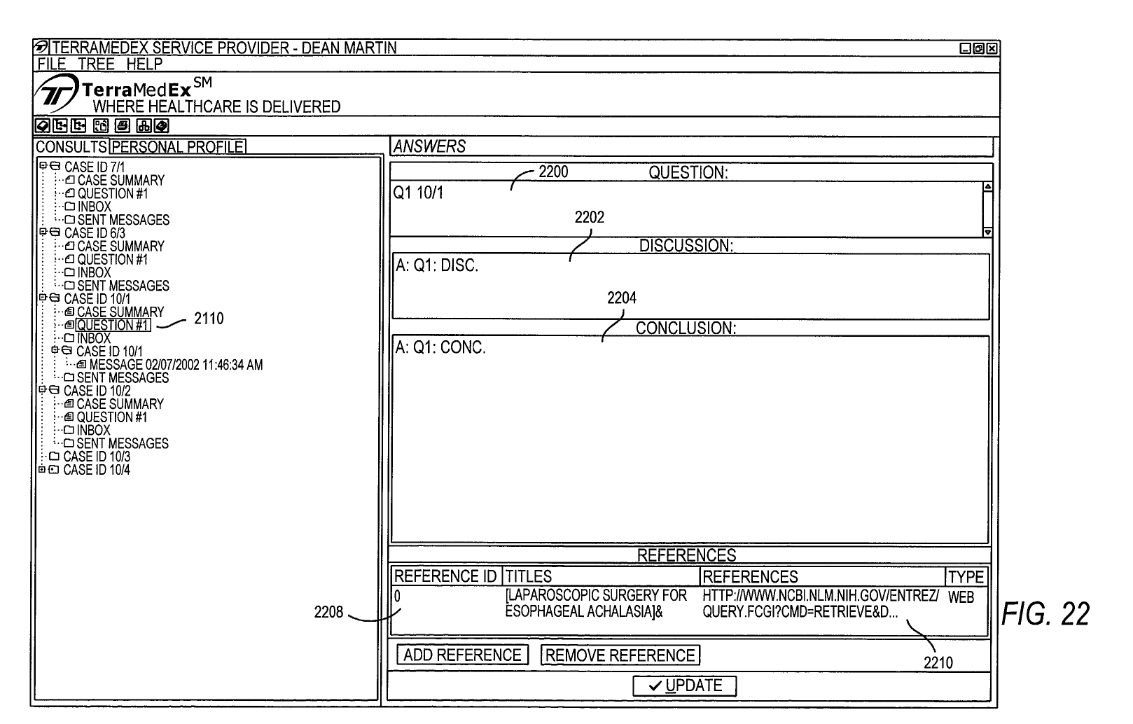

Referring to FIG. 22, if the service provider clicks on the question tab 2110, then the service provider can view a series of fields in the right hand portion of the screen, including a question field 2200 that contains the requester's question, a discussion field 2202 into which the service provider can enter a discussion of the question and relevant data, a conclusion field 2204 into which the service provider enters a conclusion about the question, and a reference field 2208 through which the service provider can identify references to which the service requester may wish to refer to understand the discussion and conclusions. The reference field 2208 may allow the service provider to attach files, or to identify links 2210 by which a service requester can access information from, for example, the worldwide web.

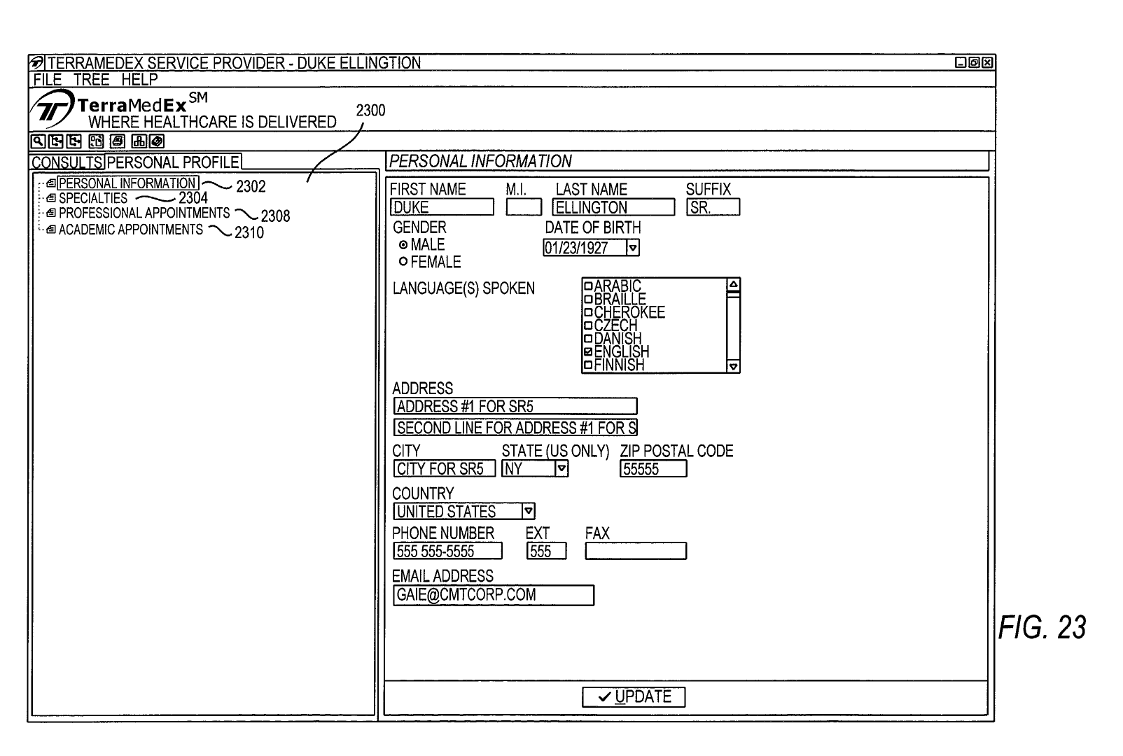

Referring to FIG. 23, a service requester may also be provided with a software interface (which might be web interface, a downloaded program, an ASP software program, or the like) by which the service requester can register. As with the service provider, a listing 2300 provides a list of categories in which a service requester may enter demographic information, such as personal information 2302, specialties 2304, professional appointments 2308, or academic appointments 2310. The demographic information may be similar to that provided by service providers, because many service requesters may be professionals the same or similar fields to the service providers.

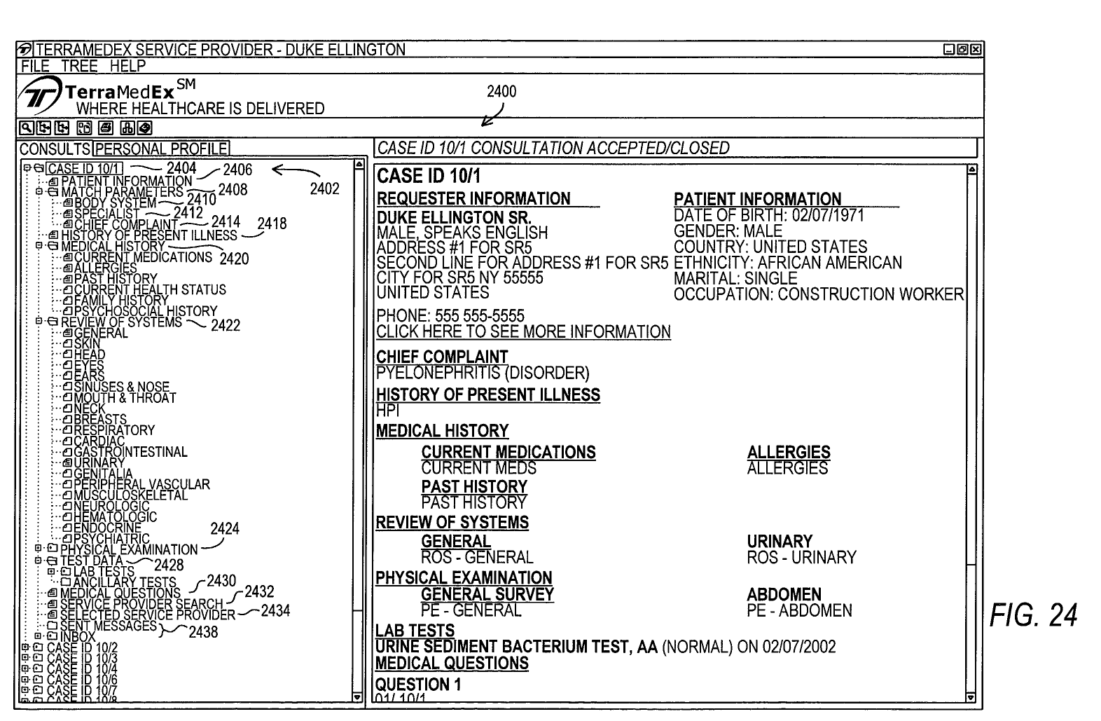

Referring to FIG. 24, through a screen 2400 a service requester can enter all data needed in order to match a question or questions to an appropriate service provider, and to obtain a consultation from that service provider. A listing 2402 may include a case identifier 2404 for the service requester's first service request. The case can then be expanded into categories needed to process the request, such as patient information 2406, match parameters 2408 (such as the body system 2410, the specialist 2412, and chief complaint 2414 in the health care field). The case listing 2404 can also include the history of the present illness 2418, a medical history 2420, a review of body systems 2422, physical examination records 2424, test data 2428, medical questions 2430, a search field for a service provider 2432, a field for a selected service provider 2434, and message box 2438. By completing the information fields in the listing 2402, the service requester enters the data required in order to obtain a consultation.

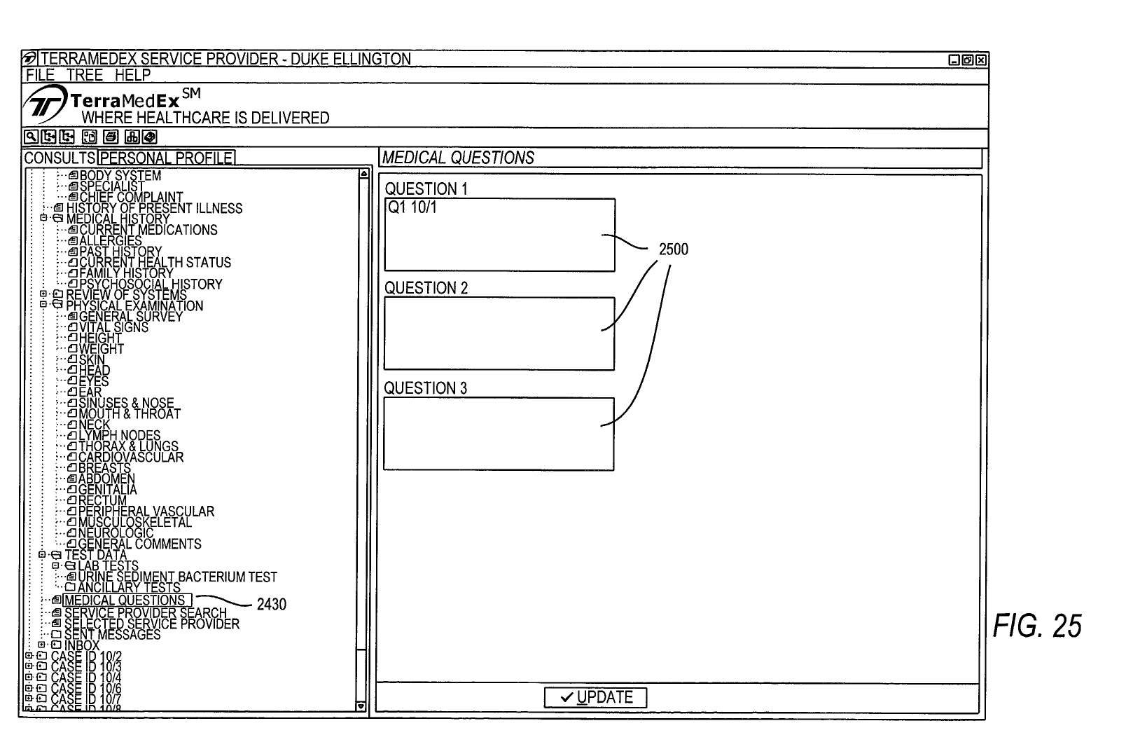

Referring to FIG. 25, the service requester can activate the medical questions field 2430 by clicking on the tab. The service requester can then enter questions into the question fields 2500. In embodiments the questions may be entered in free text, but in other embodiments the service requester may be provided with templates, a wizard, or the like for guiding the service requester into forming the questions using a preferred or required terminology set. Again, the embodiment shown is for a health care question, but with an appropriate terminology set questions can be entered for any type of profession.

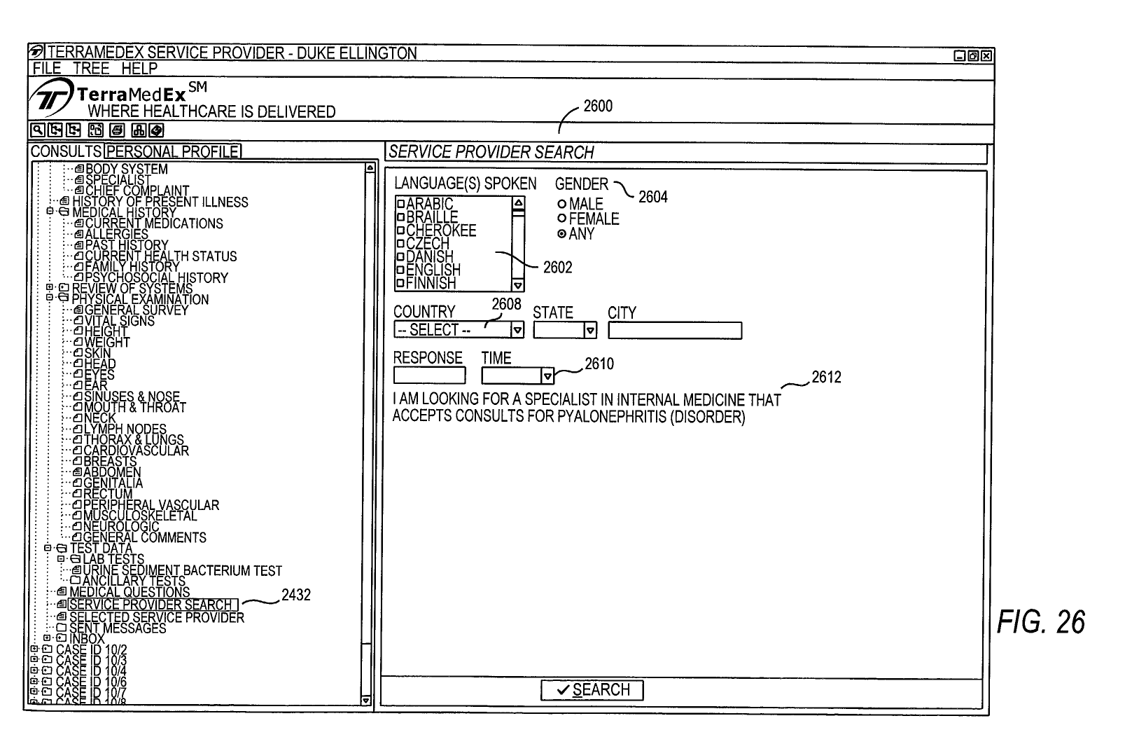

Referring to FIG. 26, a screen 2600 shows a service provider search initiated by clicking the service provider search tab 2432 on the left hand listing. The search allows the service requester to specify areas needed for the matching algorithms described above, such as languages 2602, gender 2604, location 2608, and response time 2610. The search can also include a field 2612 for entering the subject of the request, or the software can build the subject matter by deriving it from the already entered data from the chief complaint field and the question fields. Once the data is entered in the screen 2600 in the various fields the system can identify a set of service providers who match the fields, showing the service requester the profiles of the highest-ranking service providers.

All patents, patent applications, and publications mentioned herein are hereby incorporated by reference. While the invention has been described in connection with certain preferred embodiments, other embodiments may be readily comprehended by persons of ordinary skill in the art and should be understood to be encompassed herein, as limited only by the claims.

1. A method of facilitating a marketplace for knowledge, comprising:
(a) providing a set of market rules for allowing entities to interact in the marketplace;
(b) providing a builder application for allowing an enterprise to define a set of enterprise rules for interacting with the enterprise, the enterprise rules consistent with the market rules; and
(c) providing a profiling module for allowing a service provider to register with an enterprise, the profiling module facilitating creation of a representation of the service provider's knowledge consistent with the enterprise rules and the market rules.

2. A method of claim 1, further comprising an office module for allowing a service provider to establish a view of the service provider's knowledge that is consistent with the nature of the service provider's desired interaction with the enterprise.

3. A method of claim 1, wherein market rules require the use of terminology selected from a predefined terminology set.

4. A method of claim 3, wherein the terminology set is selected from the group consisting of a health care set, a medical set, a surgical set, a legal set, an engineering set, an accounting set, a manufacturing set, a science set, a biology set, a chemistry set, a physics set, a mathematics set, an economics set, a language set, a linguistics set, a consulting set, a business set, a biotechnology set, a telecommunications set, a computer language set, a computer science set, a research set, and a corporate set.

5. A method of claim 1, wherein the builder application facilitates creation of sub-enterprises having sub-enterprise rules that are consistent with the enterprise rules.

6. A method of claim 1, wherein the profiling module facilitates the creation of multiple views of a service provider's knowledge.

7. A method of claim 6, wherein the multiple views allow the service provider to interact with different enterprises according to different preferences of the service provider.

8. A method of creating a marketplace for knowledge, comprising:
(a) creating a set of rules for governing interactions of a plurality of entities in the marketplace, the entities comprising enterprises, sub-enterprises, service providers and service requesters;
(b) enabling enterprises and sub-enterprises to establish rules for allowing other entities to interacting with them;
(c) creating a hierarchy of entities within the marketplace; and
(d) providing for inheritance of rules by entities according to the hierarchy.

9. A method of claim 8, further comprising requiring use of a predefined terminology set.

10. A method of claim 9, wherein the terminology set is selected from the group consisting of a health care set, a medical set, a surgical set, a legal set, an engineering set, an accounting set, a manufacturing set, a science set, a biology set, a chemistry set, a physics set, a mathematics set, an economics set, a language set, a linguistics set, a consulting set, a business set, a biotechnology set, a telecommunications set, a computer language set, a computer science set, a research set, and a corporate set.

11. A method of facilitating a marketplace, comprising:
(a) providing an enterprise builder tool for allowing an administrator to define a set of rules for an enterprise to operate in the marketplace;
(b) providing a sub-enterprise builder tool for allowing the administrator to set rules for a sub-enterprise to operate in the marketplace, the sub-enterprise builder tool configured to allow sub-enterprise rules that are consistent with the rules for a parent enterprise of the sub-enterprise; and
(c) providing a profiling module for allowing a service provider to represent a knowledge set of the service provider.

12. A method of claim 11, wherein the profiling module allows the service provider to create multiple views of the service provider's knowledge set and business roles.

13. A method of claim 11, wherein the profiling module requires use of a predefined terminology set.

14. A method of claim 13, wherein the terminology set is selected from the group consisting of a health care set, a medical set, a surgical set, a legal set, an engineering set, an accounting set, a manufacturing set, a science set, a biology set, a chemistry set, a physics set, a mathematics set, an economics set, a language set, a linguistics set, a consulting set, a business set, a biotechnology set, a telecommunications set, a computer language set, a computer science set, a research set, and a corporate set.

15. A method of claim 11, further comprising providing a service request module for allowing a service requester to form a service request.

16. A method of claim 15, wherein the service request module requires use of a predefined terminology set.

17. A method of claim 16, wherein the terminology set is selected from the group consisting of a health care set, a medical set, a surgical set, a legal set, an engineering set, an accounting set, a manufacturing set, a science set, a biology set, a chemistry set, a physics set, a mathematics set, an economics set, a language set, a linguistics set, a consulting set, a business set, a biotechnology set, a telecommunications set, a computer language set, a computer science set, a research set, and a corporate s

18. A method of claim 15, further comprising providing a matching module for matching a service request to at least one service provider.

19. A method of claim 18, further comprising a transaction module for supporting a transaction between a service requester and a service provider.

20. A method of facilitating affiliation of an enterprise with a knowledge marketplace, comprising:
(a) providing a builder application for allowing the enterprise to enter enterprise information in a format consistent with rules for the marketplace;
(b) providing a classification process for allowing the enterprise to classify itself in at least one category among a set of categories of enterprises;
(c) providing a business rule process for allowing the enterprise to determine business rules by which others may do business with the enterprise; and
(d) providing a transaction module for allowing an entity to transact business with the enterprise.

21. A method of claim 20, wherein the builder application is at least one of a web-based application, a terminology-driven application, and a client-server application.

22. A method of claim 20, wherein the builder application is served to a user by an application service provider module.

23. A method of claim 20, wherein at least a portion of the builder application is downloaded to a user's computer.

24. A computer-based system for facilitating a marketplace, comprising:
(a) an enterprise interface for allowing an enterprise to join the marketplace;
(b) a service provider interface for allowing a service provider to affiliate with an enterprise;
(c) a service requester interface for allowing a service requester to make a service request; and
(d) a matching module for matching a service request to at least one service provider, wherein the service requester interface requires the service requester to make the service request using terminology from a predetermined terminology set.

25. A system of claim 24, wherein the terminology set is selected from the group consisting of a health care set, a medical set, a surgical set, a legal set, an engineering set, an accounting set, a manufacturing set, a science set, a biology set, a chemistry set, a physics set, a mathematics set, an economics set, a language set, a linguistics set, a consulting set, a business set, a biotechnology set, a telecommunications set, a computer language set, a computer science set, a research set, and a corporate s

26. A method of facilitating a service between a service requester and a service provider, comprising:
(a) providing a profiling process for allowing a plurality of service providers to establish a profile of the service provider's intellectual capital;
(b) providing a data requirements definition process for allowing a service provider to establish the data it requires in order to perform a service;
(c) providing a request process for allowing a service requester to request service; and
(d) providing a matching process for matching the request for service to a service provider.

27. A method of claim 26, wherein the data requirements use a predefined terminology set.

28. A method of claim 27, wherein the terminology set is selected from the group consisting of a health care set, a medical set, a surgical set, a legal set, an engineering set, an accounting set, a manufacturing set, a science set, a biology set, a chemistry set, a physics set, a mathematics set, an economics set, a language set, a linguistics set, a consulting set, a business set, a biotechnology set, a telecommunications set, a computer language set, a computer science set, a research set, and a corporate s

29. A method of claim 26, wherein the marketplace is a marketplace for specialized knowledge.

30. A method of claim 26, wherein the profiling process further comprises establishing a set of knowledge qualifications for representing knowledge and representing the knowledge qualifications of the knowledge provider as a commodity.

31. A method of claim 26, further comprising providing a transaction facility, wherein the transaction facility facilitates a transaction among a service requester and a service provider.

32. A method of claim 31, wherein determining the price of the transaction comprises making reference to the commodity representation of the knowledge provider's knowledge.

33. A system for providing a marketplace for knowledge, comprising:
(a) a communications facility for supporting communications among a plurality of geographically distributed parties;
(b) a data storage facility for storing data that is associated with the knowledge of a knowledge provider; and
(c) an interaction process for supporting an interaction among a service provider and a service requester, wherein the interaction process comprises a facility for representing a knowledge set of a knowledge provider as a commodity.

34. A system of claim 33, wherein the marketplace is a marketplace for specialized knowledge.

35. A system of claim 34, wherein the marketplace is for knowledge selected from the group consisting of medical knowledge, health care knowledge, surgical knowledge, animal health knowledge, legal knowledge, intellectual property knowledge, accounting knowledge, auditing knowledge, environmental knowledge, consulting knowledge, management consulting knowledge, sales knowledge, marketing knowledge, engineering knowledge, scientific knowledge, chemistry knowledge, biology knowledge, biochemistry knowledge, civil engineering knowledge, industrial management knowledge, education knowledge, publishing knowledge, public relations knowledge, investment banking knowledge, securities knowledge, insurance knowledge, sports knowledge, interest group knowledge, patient association knowledge, association knowledge, and manufacturing knowledge.

36. A system of claim 33, further comprising a representation process of the interaction module, wherein the interaction module includes processes for establishing a set of knowledge qualifications for representing knowledge, determining the knowledge qualifications of a knowledge provider consistent with the set of knowledge qualifications, and representing the knowledge qualifications of the knowledge provider as a commodity according to the set of knowledge qualifications.

37. A system of claim 33, further comprising a transaction facility, wherein the transaction facility facilitates a transaction among a knowledge seeker and a knowledge provider.

38. A system of claim 37, wherein determining the price of the transaction comprises making reference to the commodity representation of the knowledge provider's knowledge.

39. A method of providing a knowledge marketplace, comprising:
(a) providing a host computer system for facilitating the manipulation of data related to the marketplace, wherein the host computer system comprises at least one server, at least one database, and at least one operating system;
(b) accessing a communication facility for facilitating remote interaction with the host computer system, wherein the communication facility is selected from the group consisting of the Internet, the Worldwide Web, an intranet, a local area network, a wireless network, and a wide area network;
(c) providing an interaction module for facilitating an interaction among a provider of knowledge and a seeker of knowledge, wherein the interaction process comprises a communication facility and a facility for representing the knowledge set of a provider as a commodity;
(d) providing a profiling process of the interaction module wherein the interaction module further comprises establishing a set of knowledge qualifications for representing knowledge, determining the knowledge qualifications of a knowledge provider within the set, and representing the knowledge qualifications of the knowledge provider as a commodity; and
(e) providing a transaction facility, wherein the transaction facility facilitates a transaction among a knowledge seeker and a knowledge provider, wherein determining the price of the transaction comprises making reference to the commodity representation of the knowledge provider's knowledge.

40. A method of claim 39, wherein the marketplace is for knowledge selected from the group consisting of medical knowledge, health care knowledge, surgical knowledge, animal health knowledge, legal knowledge, intellectual property knowledge, accounting knowledge, auditing knowledge, environmental knowledge, consulting knowledge, management consulting knowledge, sales knowledge, marketing knowledge, engineering knowledge, scientific knowledge, chemistry knowledge, biology knowledge, biochemistry knowledge, civil engineering knowledge, industrial management knowledge, education knowledge, publishing knowledge, public relations knowledge, investment banking knowledge, securities knowledge, insurance knowledge, sports knowledge, interest group knowledge, patient association knowledge, association knowledge, and manufacturing knowledge.

41. A method of providing a marketplace for a professional service, comprising:
(a) providing a facility for permitting a service provider to digitally present a service offering that it wishes to provide through the marketplace;
(b) establishing a hierarchy of the types of services that are provided in the profession of the service provider;
(c) using a predefined semantic terminology set for describing the types of services provided in the profession of the service provider; and
(d) establishing a profile-building module for assisting the service provider in creating a service description that uses the semantic terminology and that positions the service offering in the hierarchy.

42. A method of matching a service provider to a service request, comprising:
(a) establishing a semantic terminology for a domain of the request;
(b) establishing a hierarchy of services that can be provided within the domain;
(c) facilitating a service request using the semantic terminology, the service request having service requirements;
(d) identifying a position within the hierarchy of a service that matches the requirements of the service request; and
(e) identifying a service provider who provides the service.

43. A method of claim 41, further comprising facilitating a transaction between the service provider and the requester of the service request wherein the service provider provides the service.

44. A method of claim 41, wherein the service request is a request that requires services from multiple service providers, and wherein the step of identifying a service provider comprises identifying multiple service providers.

45. A method of facilitating knowledge exchange, comprising:
(a) establishing a process for allowing a service requester to request an electronic, knowledge-based service from a service provider;
(b) establishing a prerequisite data set desired by the service provider for assisting the service provider in determining whether to accept a request for service; and
(c) routing a service request to a service provider based on completed data sets of a service requester.

46. A method of facilitating a marketplace for knowledge, comprising:
(a) accessing a communications facility for supporting communications among a plurality of geographically distributed parties;
(b) providing a data storage facility for storing data that is associated with the knowledge of a knowledge provider; and
(c) providing an interaction process, for supporting an interaction among a provider of knowledge and a seeker of knowledge, wherein the interaction process comprises a facility for representing the knowledge set of a knowledge provider as a commodity using a predetermined terminology set.
